(19) United States
(12) Patent Application Publication
(10) Pub. No.: US 2026/0313152 A1
(43) Pub. Date: Oct. 8, 2026

(54) IMAGE ENCODING/DECODING METHOD AND RECORDING MEDIUM STORING BITSTREAM

(71) Applicant: KT CORPORATION, Gyeonggi-do (KR)

(72) Inventor: Sung Won LIM, Gyeonggi-do (KR)

(73) Assignee: KT CORPORATION, Gyeonggi-do (KR)

(21) Appl. No.: 19/107,561

(22) PCT Filed: Sep. 6, 2023
(86) PCT No.: PCT/KR2023/013319

§ 371 Date: Feb. 27, 2025

(30) Foreign Application Priority Data
Sep. 6, 2022 (KR) 10-2022-0112803
Sep. 5, 2023 (KR) 10-2023-0117722

(51) Int. Cl. H04N 19/52; H04N 19/119; H04N 19/139; H04N 19/176

(52) U.S. Cl. CPC H04N 19/52; H04N 19/119; H04N 19/139; H04N 19/176

(57) ABSTRACT

An image decoding method according to the present disclosure may comprise obtaining a first prediction block for the current block; obtaining a second prediction block for the current block; and obtaining a final prediction block for the current block on the basis of a weighted sum operation of the first prediction block and the second prediction block. In this instance, the first prediction block is obtained by performing motion compensation on each of first sub-blocks generated when a first partition type is applied to the current block, and the second prediction block is obtained by performing motion compensation on each of second sub-blocks generated when a second partition type is applied to the current block.

### TECHNICAL FIELD

The present disclosure relates to a method and a device for processing a video signal.

### BACKGROUND ART

Recently, demands for high-resolution and high-quality images such as HD (High Definition) images and UHD (Ultra High Definition) images have increased in a variety of application fields. As image data becomes high-resolution and high-quality, the volume of data relatively increases compared to the existing image data, so when image data is transmitted by using media such as the existing wire and wireless broadband circuit or is stored by using the existing storage medium, expenses for transmission and expenses for storage increase. High efficiency image compression technologies may be utilized to resolve these problems which are generated as image data becomes high-resolution and high-quality.

There are various technologies such as an inter prediction technology which predicts a pixel value included in a current picture from a previous or subsequent picture of a current picture with an image impression technology, an intra prediction technology which predicts a pixel value included in a current picture by using pixel information in a current picture, an entropy encoding technology which assigns a short sign to a value with high appearance frequency and assigns a long sign to a value with low appearance frequency and so on, and image data may be effectively compressed and transmitted or stored by using these image compression technologies.

On the other hand, as demands for a high-resolution image have increased, demands for stereo-scopic image contents have increased as a new image service. A video compression technology for effectively providing high-resolution and ultra high-resolution stereo-scopic image contents has been discussed.

### DISCLOSURE

### Technical Problem

The present disclosure is to provide a method for performing motion estimation based on a pre-reconstructed picture on a decoder side and a device for performing the same.

The present disclosure is to provide a method for improving prediction accuracy by combining a plurality of inter prediction modes and a device for performing the same.

The present disclosure is to provide a method for removing discontinuity at a sub-block boundary by using a plurality of prediction blocks and a device for performing the same.

Technical effects of the present disclosure may be non-limited by the above-mentioned technical effects, and other unmentioned technical effects may be clearly understood from the following description by those having ordinary skill in the technical field to which the present disclosure pertains.

### Technical Solution

An image decoding method according to the present disclosure may include obtaining a first prediction block for a current block; obtaining a second prediction block for the current block; and obtaining a final prediction block for the current block based on a weighted sum operation of the first prediction block and the second prediction block. In this instance, the first prediction block may be obtained by performing motion compensation on each of first sub-blocks generated when a first partition type is applied to the current block, and the second prediction block may be obtained by performing motion compensation on each of second sub-blocks generated when a second partition type is applied to the current block.

An image encoding method according to the present disclosure may include obtaining a first prediction block for a current block; obtaining a second prediction block for the current block; and obtaining a final prediction block for the current block based on a weighted sum operation of the first prediction block and the second prediction block. In this instance, the first prediction block may be obtained by performing motion compensation on each of first sub-blocks generated when a first partition type is applied to the current block, and the second prediction block may be obtained by performing motion compensation on each of second sub-blocks generated when a second partition type is applied to the current block.

In an image decoding/encoding method according to the present disclosure, the first partition type and the second partition type may be different in at least one of a position of a partition line partitioning the current block, the number of partition lines, a size of a sub-block generated by partitioning the current block or a shape of a sub-block.

In an image decoding/encoding method according to the present disclosure, the first sub-blocks generated by the first partition type may have an equal size and among the second sub-blocks generated by the second partition type, a part of the second sub-blocks not adjacent to a boundary of the current block may have an equal size and the others of the second sub-blocks adjacent to a boundary of the current block may have a smaller size.

In an image decoding/encoding method according to the present disclosure, the weighted sum operation may be performed by applying a first weight to the first prediction block and a second weight to the second prediction block.

In an image decoding/encoding method according to the present disclosure, the first weight and the second weight may be variably determined according to a prediction target position.

In an image decoding/encoding method according to the present disclosure, motion compensation for the first sub-blocks may be performed based on a first motion information derivation method, and motion compensation for the second sub-blocks may be performed based on a second motion information derivation method.

In an image decoding/encoding method according to the present disclosure, the first motion information derivation method may be an affine model, and the second motion information derivation method may be Sub-block Temporal Motion Vector Prediction (SbTMVP).

In an image decoding/encoding method according to the present disclosure, motion information for the first sub-blocks to which the first motion information derivation method is applied may be derived based on a first position of a sub-block, and motion information for the second sub-blocks to which the second motion information derivation method is applied may be derived based on a second position of a sub-block.

The features briefly summarized above for the present disclosure are just an exemplary aspect of a detailed description for the present disclosure described below, and do not limit the scope of the present disclosure.

### Technical Effect

According to the present disclosure, signaling overhead may be reduced by performing motion estimation based on a pre-reconstructed picture on a decoder side.

According to the present disclosure, prediction accuracy may be improved by combining a plurality of inter prediction modes.

According to the present disclosure, a plurality of prediction blocks may be used to remove discontinuity at a sub-block boundary, improving prediction accuracy.

Effects obtainable from the present disclosure are not limited to the above-mentioned effects and other unmentioned effects may be clearly understood from the following description by those having ordinary skill in the technical field to which the present disclosure pertains.

### BRIEF DESCRIPTION OF DRAWINGS

FIG. 1 is a block diagram showing an image encoding device according to an embodiment of the present disclosure.

FIG. 2 is a block diagram showing an image decoding device according to an embodiment of the present disclosure.

FIG. 3 shows an example in which motion estimation is performed.

FIGS. 4 and 5 show an example in which a prediction block of a current block is generated based on motion information generated through motion estimation.

FIG. 6 shows a position referred to for deriving a motion vector prediction value.

FIG. 7 is a diagram for describing a template-based motion estimation method.

FIG. 8 shows examples in which a template is configured.

FIG. 9 is a diagram for describing a motion estimation method based on a bilateral matching method.

FIG. 10 is a diagram for describing a motion estimation method based on a unidirectional matching method.

FIGS. 11 and 12 show an example in which a prediction block is generated according to the precision of a motion vector.

FIG. 13 represents an example in which motion compensation based on a translation model and a zooming model is performed for a current block.

FIG. 14 represents an example in which motion compensation based on a translation model and a rotation model is performed for a current block.

FIGS. 15 and 16 represent an example in which a prediction block for a current block is generated by using control point motion vectors.

FIG. 17 represents an example in which a prediction block for a current block is generated by using three control point motion vectors.

FIG. 18 represents an example in which a motion vector is derived in a unit of a sub-block.

FIGS. 19 and 20 represent an example in which a motion vector is derived in a unit of a sub-block within a current block when SbTMVP is applied.

FIG. 21 is a diagram illustrating a first partition type and a second partition type.

FIG. 22 is to describe a weighted sum operation for a first prediction block obtained based on a first partition type and a second prediction block obtained based on a second partition type shown in FIG. 21.

FIG. 23 represents an example in which a plurality of prediction blocks are obtained while maintaining a partition method in the same manner.

### MODE FOR INVENTION

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference numeral was used for a similar component while describing each drawing.

A term such as first, second, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term of and/or includes a combination of a plurality of relative entered items or any item of a plurality of relative entered items.

When a component is referred to as being “linked” or “connected” to other component, it should be understood that it may be directly linked or connected to that other component, but other component may exist in the middle. On the other hand, when a component is referred to as being “directly linked” or “directly connected” to other component, it should be understood that other component does not exist in the middle.

As terms used in this application are just used to describe a specific embodiment, they are not intended to limit the present disclosure. Expression of the singular includes expression of the plural unless it clearly has a different meaning contextually. In this application, it should be understood that a term such as “include” or “have”, etc. is to designate the existence of characteristics, numbers, steps, motions, components, parts or their combinations entered in the specification, but is not to exclude a possibility of addition or existence of one or more other characteristics, numbers, steps, motions, components, parts or their combinations in advance.

Hereinafter, referring to the attached drawings, a desirable embodiment of the present disclosure will be described in more detail. Hereinafter, the same reference numeral is used for the same component in a drawing and an overlapping description for the same component is omitted.

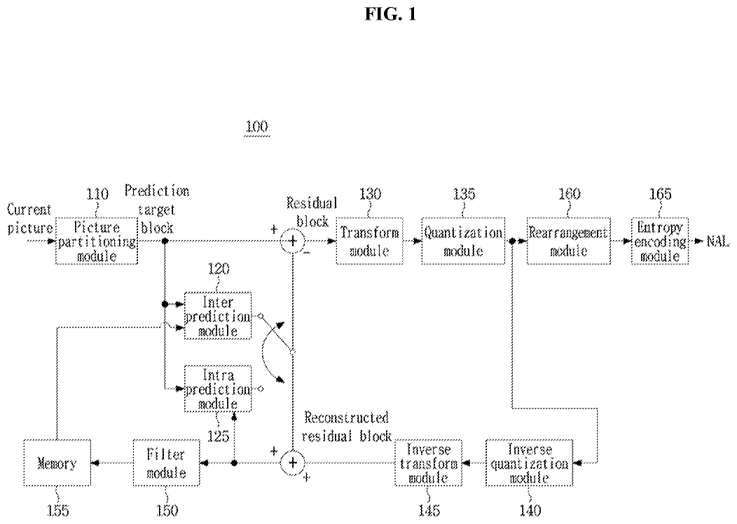

FIG. 1 is a block diagram showing an image encoding device according to an embodiment of the present disclosure.

Referring to FIG. 1, an image encoding device 100 may include a picture partitioning unit 110, prediction units 120 and 125, a transform unit 130, a quantization unit 135, a rearrangement unit 160, an entropy encoding unit 165, a dequantization unit 140, an inverse-transform unit 145, a filter unit 150, and a memory 155.

As each construction unit shown in FIG. 1 is independently shown to represent different characteristic functions in an image encoding device, it does not mean that each construction unit is constituted by separated hardware or one software unit. That is, as each construction unit is included by being enumerated as each construction unit for convenience of a description, at least two construction units of each construction unit may be combined to constitute one construction unit or one construction unit may be partitioned into a plurality of construction units to perform a function, and even an integrated embodiment and a separated embodiment of each construction unit are also included in a scope of a right of the present disclosure unless they are departing from the essence of the present disclosure.

Further, some components may be just an optional component for improving performance, not a necessary component which perform an essential function in the present disclosure. The present disclosure may be implemented by including only a construction unit necessary for implementing the essence of the present disclosure excluding a component used to just improve performance, and a structure including only a necessary component excluding an optional component used to just improve performance is also included in a scope of a right of the present disclosure.

A picture partitioning unit 110 may partition an input picture into at least one processing unit. In this case, a processing unit may be a prediction unit (PU), a transform unit (TU) or a coding unit (CU). In a picture partitioning unit 110, one picture may be partitioned into a combination of a plurality of coding units, prediction units and transform units and a picture may be encoded by selecting a combination of one coding unit, prediction unit and transform unit according to a predetermined standard (e.g., a cost function).

For example, one picture may be partitioned into a plurality of coding units. In order to partition a coding unit in a picture, a recursive tree structure such as a quad tree, a ternary tree, or a binary tree may be used, and a coding unit which is partitioned into other coding units by using one image or the largest coding unit as a route may be partitioned with as many child nodes as the number of partitioned coding units. A coding unit which is no longer partitioned according to a certain restriction becomes a leaf node. As an example, when it is assumed that quad tree partitioning is applied to one coding unit, one coding unit may be partitioned into up to four other coding units.

Hereinafter, in an embodiment of the present disclosure, a coding unit may be used as a unit for encoding or may be used as a unit for decoding.

A prediction unit may be partitioned with at least one square or rectangular shape, etc. in the same size in one coding unit or may be partitioned so that any one prediction unit of prediction units partitioned in one coding unit can have a shape and/or a size different from another prediction unit.

In intra prediction, a transform unit may be set to be the same as a prediction unit. In this case, after a coding unit is partitioned into a plurality of transform units, intra prediction may be performed per each transform unit. A coding unit may be partitioned in a horizontal direction or in a vertical direction. The number of transform units generated by partitioning a coding unit may be 2 or 4 according to a size of a coding unit.

Prediction units 120 and 125 may include an inter prediction unit 120 performing inter prediction and an intra prediction unit 125 performing intra prediction. Whether to perform inter prediction or intra prediction for a coding unit may be determined and detailed information according to each prediction method (e.g., an intra prediction mode, a motion vector, a reference picture, etc.) may be determined. In this case, a processing unit that prediction is performed may be different from a processing unit that a prediction method and details are determined. For example, a prediction method, a prediction mode, etc. may be determined in a coding unit and prediction may be performed in a prediction unit or in a transform unit. A residual value (a residual block) between a generated prediction block and an original block may be input to a transform unit 130. In addition, prediction mode information, motion vector information, etc. used for prediction may be encoded with a residual value in an entropy encoding unit 165 and may be transmitted to a decoding device. When a specific encoding mode is used, an original block may be encoded as it is and transmitted to a decoding unit without generating a prediction block through prediction units 120 or 125.

An inter prediction unit 120 may predict a prediction unit based on information on at least one picture of a previous picture or a subsequent picture of a current picture, or in some cases, may predict a prediction unit based on information on some encoded regions in a current picture. An inter prediction unit 120 may include a reference picture interpolation unit, a motion prediction unit and a motion compensation unit.

A reference picture interpolation unit may receive reference picture information from a memory 155 and generate pixel information equal to or less than an integer pixel in a reference picture. For a luma pixel, a 8-tap DCT-based interpolation filter having a different filter coefficient may be used to generate pixel information equal to or less than an integer pixel in a ¼ pixel unit. For a chroma signal, a 4-tap DCT-based interpolation filter having a different filter coefficient may be used to generate pixel information equal to or less than an integer pixel in a ⅛ pixel unit.

A motion prediction unit may perform motion prediction based on a reference picture interpolated by a reference picture interpolation unit. As a method for calculating a motion vector, various methods such as FBMA (Full search-based Block Matching Algorithm), TSS (Three Step Search), NTS (New Three-Step Search Algorithm), etc. may be used. A motion vector may have a motion vector value in a ½ or ¼ pixel unit based on an interpolated pixel. A motion prediction unit may predict a current prediction unit by varying a motion prediction method. As a motion prediction method, various methods such as a skip method, a merge method, an advanced motion vector prediction (AMVP) method, an intra block copy method, etc. may be used.

An intra prediction unit 125 may generate a prediction unit based on reference pixel information that is pixel information in a current picture. Reference pixel information may be derived from one selected among a plurality of reference pixel lines. A N-th reference pixel line among a plurality of reference pixel lines may include left pixels where an x-axis difference with a top-left pixel within a current block is N and top pixels where an y-axis difference with the top-left pixel is N. The number of reference pixel lines that may be selected by a current block may be 1, 2, 3, or 4.

When a neighboring block in a current prediction unit is a block which performed inter prediction and accordingly, a reference pixel is a pixel which performed inter prediction, a reference pixel included in a block which performed inter prediction may be used by being replaced with reference pixel information of a neighboring block which performed intra prediction. In other words, when a reference pixel is unavailable, unavailable reference pixel information may be used by being replaced with at least one information among the available reference pixels.

A prediction mode in intra prediction may have a directional prediction mode using reference pixel information according to a prediction direction and a non-directional mode not using directional information when performing prediction. A mode for predicting luma information may be different from a mode for predicting chroma information and intra prediction mode information used for predicting luma information or predicted luma signal information may be utilized to predict chroma information.

When a size of a prediction unit is the same as that of a transform unit in performing intra prediction, intra prediction for a prediction unit may be performed based on a pixel at a left position of a prediction unit, a pixel at a top-left position and a pixel at a top position.

An intra prediction method may generate a prediction block after applying a smoothing filter to a reference pixel according to a prediction mode. According to a selected reference pixel line, whether to apply a smoothing filter may be determined.

In order to perform an intra prediction method, an intra prediction mode in a current prediction unit may be predicted from an intra prediction mode in a prediction unit around a current prediction unit. When a prediction mode in a current prediction unit is predicted by using mode information predicted from a surrounding prediction unit, information that a prediction mode in a current prediction unit is the same as a prediction mode in a surrounding prediction unit may be transmitted by using predetermined flag information if an intra prediction mode in a current prediction unit is the same as an intra prediction mode in a surrounding prediction unit, and prediction mode information of a current block may be encoded by performing entropy encoding if a prediction mode in a current prediction unit is different from a prediction mode in a surrounding prediction unit.

In addition, a residual block may be generated which includes information on a residual value that is a difference value between a prediction unit which performed prediction based on a prediction unit generated in prediction units 120 and 125 and an original block in a prediction unit. A generated residual block may be input to a transform unit 130.

A transform unit 130 may transform an original block and a residual block including residual value information in a prediction unit generated through prediction units 120 and 125 by using a transform method such as DCT (Discrete Cosine Transform), DST (Discrete Sine Transform), KLT. Whether to apply DCT, DST or KLT to transform a residual block may be determined based on at least one of a size of a transform unit, a form of a transform unit, a prediction mode in a prediction unit or intra prediction mode information in a prediction unit.

A quantization unit 135 may quantize values transformed into a frequency domain in a transform unit 130. A quantization coefficient may be changed according to a block or importance of an image. A value calculated in a quantization unit 135 may be provided to a dequantization unit 140 and a rearrangement unit 160.

A rearrangement unit 160 may perform rearrangement of a coefficient value for a quantized residual value.

A rearrangement unit 160 may change a coefficient in a shape of a two-dimensional block into a shape of a one-dimensional vector through a coefficient scan method. For example, a rearrangement unit 160 may scan a DC coefficient to a coefficient in a high-frequency domain by using a zig-zag scan method and change it into a shape of a one-dimensional vector. According to a size of a transform unit and an intra prediction mode, instead of zig-zag scan, vertical scan where a coefficient in a shape of a two-dimensional block is scanned in a column direction, horizontal scan where a coefficient in a shape of a two-dimensional block is scanned in a row direction, or diagonal scan where a coefficient in a shape of a two-dimensional block is scanned in a diagonal direction may be used. In other words, which scan method among zig-zag scan, vertical directional scan, horizontal directional scan or diagonal scan will be used may be determined according to a size of a transform unit and an intra prediction mode.

An entropy encoding unit 165 may perform entropy encoding based on values calculated by a rearrangement unit 160. Entropy encoding, for example, may use various encoding methods such as exponential Golomb, CAVLC(Context-Adaptive Variable Length Coding), CABAC(Context-Adaptive Binary Arithmetic Coding).

An entropy encoding unit 165 may encode a variety of information such as residual value coefficient information and block type information in a coding unit, prediction mode information, partitioning unit information, prediction unit information and transmission unit information, motion vector information, reference frame information, block interpolation information, filtering information, etc. from a rearrangement unit 160 and prediction units 120 and 125.

An entropy encoding unit 165 may perform entropy encoding for a coefficient value in a coding unit which is input from a rearrangement unit 160.

A dequantization unit 140 and an inverse transform unit 145 dequantize values quantized in a quantization unit 135 and inversely transform values transformed in a transform unit 130. A residual value generated by a dequantization unit 140 and an inverse transform unit 145 may be combined with a prediction unit predicted by a motion prediction unit, a motion compensation unit and an intra prediction unit included in prediction units 120 and 125 to generate a reconstructed block.

A filter unit 150 may include at least one of a deblocking filter, an offset correction unit and an adaptive loop filter (ALF).

A deblocking filter may remove block distortion which is generated by a boundary between blocks in a reconstructed picture. In order to determine whether deblocking is performed, whether a deblocking filter will be applied to a current block may be determined based on a pixel included in several rows or columns included in a block. When a deblocking filter is applied to a block, a strong filter or a weak filter may be applied according to required deblocking filtering strength. In addition, in applying a deblocking filter, when horizontal filtering and vertical filtering are performed, horizontal directional filtering and vertical directional filtering may be set to be processed in parallel.

An offset correction unit may correct an offset with an original image in a unit of a pixel for an image that deblocking was performed. In order to perform offset correction for a specific picture, a region where an offset will be performed may be determined after dividing a pixel included in an image into the certain number of regions and a method in which an offset is applied to a corresponding region or a method in which an offset is applied by considering edge information of each pixel may be used.

Adaptive loop filtering (ALF) may be performed based on a value obtained by comparing a filtered reconstructed image with an original image. After a pixel included in an image is divided into predetermined groups, filtering may be discriminately performed per group by determining one filter which will be applied to a corresponding group. Information related to whether to apply ALF may be transmitted per coding unit (CU) for a luma signal and a shape and a filter coefficient of an ALF filter to be applied may vary according to each block. In addition, an ALF filter in the same shape (fixed shape) may be applied regardless of a characteristic of a block to be applied.

A memory 155 may store a reconstructed block or picture calculated through a filter unit 150 and a stored reconstructed block or picture may be provided to prediction units 120 and 125 when performing inter prediction.

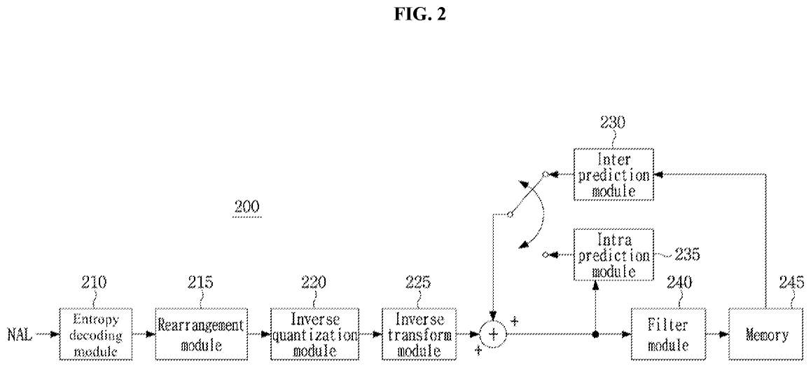

FIG. 2 is a block diagram showing an image decoding device according to an embodiment of the present disclosure.

Referring to FIG. 2, an image decoding device 200 may include an entropy decoding unit 210, a rearrangement unit 215, a dequantization unit 220, an inverse transform unit 225, prediction units 230 and 235, a filter unit 240, and a memory 245.

When an image bitstream is input from an image encoding device, an input bitstream may be decoded according to a procedure opposite to that of an image encoding device.

An entropy decoding unit 210 may perform entropy decoding according to a procedure opposite to a procedure in which entropy encoding is performed in an entropy encoding unit of an image encoding device. For example, in response to a method performed in an image encoding device, various methods such as Exponential Golomb, CAVLC (Context-Adaptive Variable Length Coding), CABAC (Context-Adaptive Binary Arithmetic Coding) may be applied.

An entropy decoding unit 210 may decode information related to intra prediction and inter prediction performed in an encoding device.

A rearrangement unit 215 may perform rearrangement based on a method that a bitstream entropy-decoded in an entropy decoding unit 210 is rearranged in an encoding unit. Coefficients expressed in a form of a one-dimensional vector may be rearranged by being reconstructed into coefficients in a form of a two-dimensional block. A rearrangement unit 215 may receive information related to coefficient scanning performed in an encoding unit and perform rearrangement through a method in which scanning is inversely performed based on scanning order performed in a corresponding encoding unit.

A dequantization unit 220 may perform dequantization based on a quantization parameter provided from an encoding device and a coefficient value of a rearranged block.

An inverse transform unit 225 may perform transform performed in a transform unit, i.e., inverse transform for DCT, DST, and KLT, i.e., inverse DCT, inverse DST and inverse KLT for a result of quantization performed in an image encoding device. Inverse transform may be performed based on a transmission unit determined in an image encoding device. In an inverse transform unit 225 of an image decoding device, a transform technique (for example, DCT, DST, KLT) may be selectively performed according to a plurality of information such as a prediction method, a size or a shape of a current block, a prediction mode, an intra prediction direction, etc.

Prediction units 230 and 235 may generate a prediction block based on information related to generation of a prediction block provided from an entropy decoding unit 210 and pre-decoded block or picture information provided from a memory 245.

As described above, when a size of a prediction unit is the same as a size of a transform unit in performing intra prediction in the same manner as an operation in an image encoding device, intra prediction for a prediction unit may be performed based on a pixel at a left position of a prediction unit, a pixel at a top-left position and a pixel at a top position, but when a size of a prediction unit is different from a size of a transform unit in performing intra prediction, intra prediction may be performed by using a reference pixel based on a transform unit. In addition, intra prediction using N×N partitioning may be used only for the smallest coding unit.

Prediction units 230 and 235 may include a prediction unit determination unit, an inter prediction unit and an intra prediction unit. A prediction unit determination unit may receive a variety of information such as prediction unit information, prediction mode information of an intra prediction method, motion prediction-related information of an inter prediction method, etc. which are input from an entropy decoding unit 210, divide a prediction unit in a current coding unit and determine whether a prediction unit performs inter prediction or intra prediction. An inter prediction unit 230 may perform inter prediction for a current prediction unit based on information included in at least one picture of a previous picture or a subsequent picture of a current picture including a current prediction unit by using information necessary for inter prediction in a current prediction unit provided from an image encoding device. Alternatively, inter prediction may be performed based on information on some regions which are pre-reconstructed in a current picture including a current prediction unit.

In order to perform inter prediction, whether a motion prediction method in a prediction unit included in a corresponding coding unit is a skip mode, a merge mode, an AMVP mode, or an intra block copy mode may be determined based on a coding unit.

An intra prediction unit 235 may generate a prediction block based on pixel information in a current picture. When a prediction unit is a prediction unit which performed intra prediction, intra prediction may be performed based on intra prediction mode information in a prediction unit provided from an image encoding device. An intra prediction unit 235 may include an adaptive intra smoothing (AIS) filter, a reference pixel interpolation unit and a DC filter. As a part performing filtering on a reference pixel of a current block, an AIS filter may be applied by determining whether a filter is applied according to a prediction mode in a current prediction unit. AIS filtering may be performed for a reference pixel of a current block by using AIS filter information and a prediction mode in a prediction unit provided from an image encoding device. When a prediction mode of a current block is a mode which does not perform AIS filtering, an AIS filter may not be applied.

When a prediction mode in a prediction unit is a prediction unit which performs intra prediction based on a pixel value which interpolated a reference pixel, a reference pixel interpolation unit may interpolate a reference pixel to generate a reference pixel in a unit of a pixel equal to or less than an integer value. When a prediction mode in a current prediction unit is a prediction mode which generates a prediction block without interpolating a reference pixel, a reference pixel may not be interpolated. A DC filter may generate a prediction block through filtering when a prediction mode of a current block is a DC mode.

A reconstructed block or picture may be provided to a filter unit 240. A filter unit 240 may include a deblocking filter, an offset correction unit and an ALF.

Information on whether a deblocking filter was applied to a corresponding block or picture and information on whether a strong filter or a weak filter was applied when a deblocking filter was applied may be provided from an image encoding device. Information related to a deblocking filter provided from an image encoding device may be provided in a deblocking filter of an image decoding device and deblocking filtering for a corresponding block may be performed in an image decoding device.

An offset correction unit may perform offset correction on a reconstructed image based on offset value information, a type of offset correction, etc. applied to an image when performing encoding.

An ALF may be applied to a coding unit based on information on whether ALF is applied, ALF coefficient information, etc. provided from an encoding device. Such ALF information may be provided by being included in a specific parameter set.

A memory 245 may store a reconstructed picture or block for use as a reference picture or a reference block and provide a reconstructed picture to an output unit.

As described above, hereinafter, in an embodiment of the present disclosure, a coding unit is used as a term of a coding unit for convenience of a description, but it may be a unit which performs decoding as well as encoding.

In addition, as a current block represents a block to be encoded/decoded, it may represent a coding tree block (or a coding tree unit), a coding block (or a coding unit), a transform block (or a transform unit), a prediction block (or a prediction unit), a block to which an in-loop filter is applied, etc. according to an encoding/decoding step. In this specification, ‘unit’ may represent a base unit for performing a specific encoding/decoding process and ‘block’ may represent a pixel array in a predetermined size. Unless otherwise classified, ‘block’ and ‘unit’ may be used interchangeably. For example, in the after-described embodiment, it may be understood that a coding block (a coding block) and a coding unit (a coding unit) are used interchangeably.

Furthermore, a picture in which a current block is included is called a current picture.

When encoding a current picture, redundant data between pictures may be removed through inter prediction. Inter prediction may be performed in a unit of a block. Specifically, the motion information of a current block may be used to generate a prediction block of a current block from a reference picture. Here, motion information may include at least one of a motion vector, a reference picture index and a prediction direction.

The motion information of a current block may be generated through motion estimation.

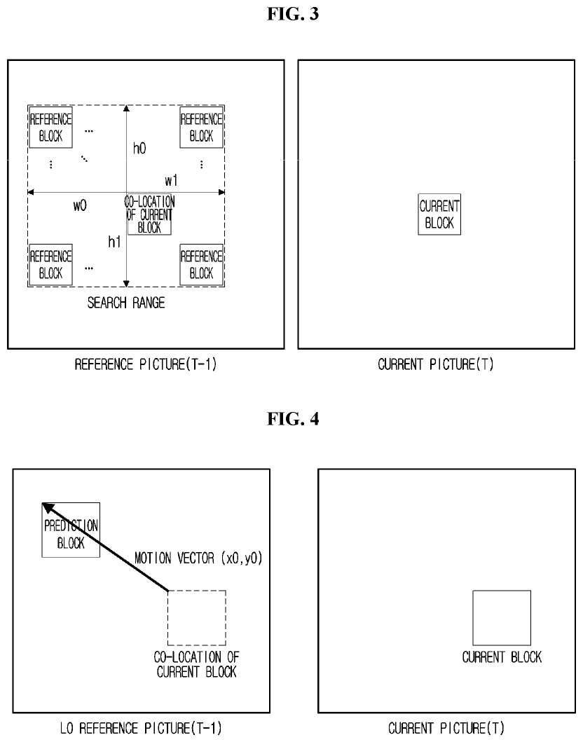

FIG. 3 shows an example in which motion estimation is performed.

In FIG. 3, it is assumed that the Picture Order Count (POC) of a current picture is T and the POC of a reference picture is (T−1).

A search range for motion estimation may be set from the same position as a reference point of a current block in a reference picture. Here, a reference point may be a position of a top-left sample of a current block.

As an example, in FIG. 3, it was illustrated that a square in a size of (w0+w01) and (h0+h1) is set to be within a search range centered on a reference point. In an example above, w0, w1, h0 and h1 may have the same value. Alternatively, at least one of w0, w1, h0 and h1 may be set to have a different value from the other. Alternatively, a size of w0, w1, h0 and h1 may be determined not to exceed a Coding Tree Unit (CTU) boundary, a slice boundary, a tile boundary or a picture boundary.

Within a search range, after reference blocks having the same size as a current block are set, a cost with a current block may be measured for each reference block. A cost may be calculated by using a similarity between two blocks.

As an example, a cost may be calculated based on the sum of absolute differences (SAD) between original samples in a current block and original samples (or reconstructed samples) in a reference block. As a SAD is smaller, a cost may be reduced.

Afterwards, a reference block with an optimal cost may be set as a prediction block of a current block by comparing a cost of each reference block.

Then, a distance between a current block and a reference block may be set as a motion vector. Specifically, a x-coordinate difference and a y-coordinate difference between a current block and a reference block may be set as a motion vector.

Furthermore, an index of a picture including a reference block specified through motion estimation is set as a reference picture index.

In addition, a prediction direction may be set based on whether a reference picture belongs to a L0 reference picture list or a L1 reference picture list.

In addition, motion estimation may be performed for each of a L0 direction and a L1 direction. When prediction is performed for both a L0 direction and a L1 direction, motion information in a L0 direction and motion information in a L1 direction may be generated, respectively.

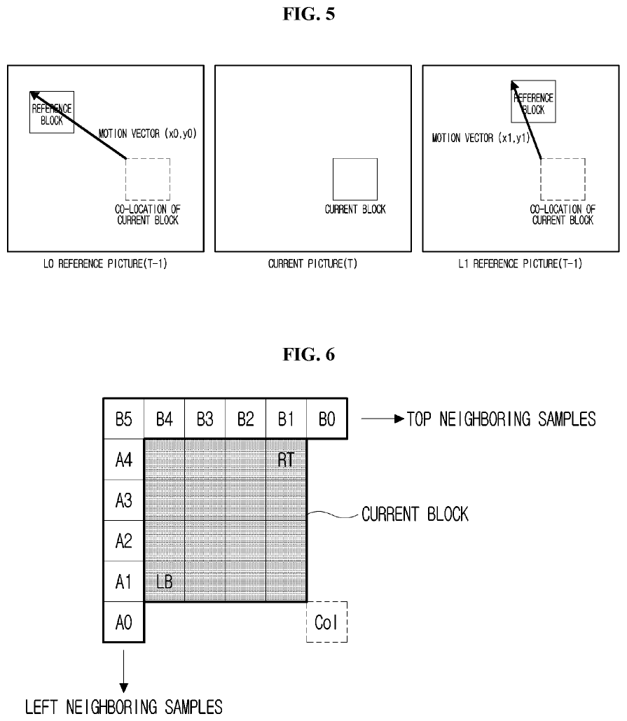

FIGS. 4 and 5 show an example in which a prediction block of a current block is generated based on motion information generated through motion estimation.

FIG. 4 shows an example in which a prediction block is generated by unidirectional (i.e., L0 direction) prediction, and FIG. 5 shows an example in which a prediction block is generated by bidirectional (i.e., L0 and L1 direction) prediction.

For unidirectional prediction, a prediction block of a current block is generated by using one motion information. As an example, motion information may include a L0 motion vector, a L0 reference picture index and prediction direction information indicating a L0 direction.

For bidirectional prediction, a prediction block is generated by using two motion information. As an example, a reference block in a L0 direction specified based on motion information for a L0 direction (L0 motion information) may be set as a L0 prediction block, and a reference block in a L1 direction specified based on motion information for a L1 direction (L1 motion information) may be generated as a L1 prediction block. Afterwards, a L0 prediction block and a L1 prediction block may be weighted to generate a prediction block of a current block.

In an example shown in FIGS. 3 to 5, it was illustrated a L0 reference picture exists in a previous direction of a current picture (i.e., a POC value is smaller than that of a current picture) and a L1 reference picture exists in a subsequent direction of a current picture (i.e., a POC value is greater than that of a current picture).

However, unlike a shown example, a L0 reference picture may exist in a subsequent direction of a current picture, or a L1 reference picture may exist in a previous direction of a current picture. As an example, both a L0 reference picture and a L1 reference picture may exist in a previous direction of a current picture, or may exist in a subsequent direction of a current picture. Alternatively, bidirectional prediction may be performed by using a L0 reference picture existing in a subsequent direction of a current picture and a L1 reference picture existing in a previous direction of a current picture.

The motion information of a block where inter prediction is performed may be stored in a memory. In this case, motion information may be stored in a unit of a sample. Specifically, the motion information of a block to which a specific sample belongs may be stored as the motion information of a specific sample. Stored motion information may be used to derive the motion information of a neighboring block to be decoded/decoded later.

In an encoder, information obtained by encoding a residual sample corresponding to a difference value between a sample of a current block (i.e., an original sample) and a prediction sample and motion information necessary for generating a prediction block may be signaled to a decoder. In a decoder, information about a signaled difference value may be decoded to derive a difference sample, and a reconstructed sample may be generated by adding a prediction sample in a prediction block generated by using motion information to the difference sample.

In this case, in order to effectively compress motion information signaled to a decoder, one of a plurality of inter prediction modes may be selected. Here, a plurality of inter prediction modes may include a motion information merge mode and a motion vector prediction mode.

A motion vector prediction mode is a mode that encodes and signals a difference value between a motion vector and a motion vector prediction value. Here, a motion vector prediction value may be derived based on motion information of a neighboring sample or a neighboring block adjacent to a current block.

FIG. 6 shows a position referred to for deriving a motion vector prediction value.

For convenience of a description, it is assumed that a current block has a size of 4×4.

In a shown example, ‘LB’ represents a sample included in the leftmost column and the bottommost row in a current block. ‘RT’ represents a sample included in the rightmost column and the topmost row in a current block. A0 to A4 represent samples neighboring the left of a current block, and B0 to B5 represent samples neighboring the top of a current block. As an example, A1 represents a sample neighboring the left of LB, and B1 represents a sample neighboring the top of RT.

Col represents a position of a sample neighboring the bottom-right of a current block in a co-located picture. A col-located picture is a picture different from a current picture, and information for specifying a col-located picture may be explicitly encoded and signaled in a bitstream. Alternatively, a reference picture having a predefined reference picture index may be set as a col-located picture.

A motion vector prediction value of a current block may be derived from at least one motion vector prediction candidate included in a motion vector prediction list.

The number of motion vector prediction candidates that may be inserted into a motion vector prediction list (i.e., a size of a list) may be predefined in an encoder and a decoder. As an example, the maximum number of motion vector prediction candidates may be 2.

A motion vector stored in a position of a neighboring sample adjacent to a current block or a scaled motion vector derived by scaling the motion vector may be inserted into a motion vector prediction list as a motion vector prediction candidate. In this case, neighboring samples adjacent to a current block may be scanned in predefined order to derive a motion vector prediction candidate.

As an example, whether a motion vector is stored at each position in the order of A0 to A4 may be confirmed. And, according to the scan order, an available motion vector found first may be inserted into a motion vector prediction list as a motion vector prediction candidate.

As another example, whether a motion vector is stored at each position in the order of A0 to A4 is confirmed, and a motion vector at a position with the same reference picture as a current block that is found first may be inserted into a motion vector prediction list as a motion vector prediction candidate. If there is no neighboring sample that has the same reference picture as a current block, a motion vector prediction candidate may be derived based on an available vector found first. Specifically, after scaling an available motion vector found first, a scaled motion vector may be inserted into a motion vector prediction list as a motion vector prediction candidate. In this case, scaling may be performed based on an output order difference between a current picture and a reference picture (i.e., a POC difference) and an output order difference between a current picture and a reference picture of a neighboring sample (i.e., a POC difference).

Furthermore, in the order of B0 to B5, whether a motion vector is stored at each position may be confirmed. And, according to the scan order, an available motion vector found first may be inserted into a motion vector prediction list as a motion vector prediction candidate.

As another example, whether a motion vector is stored at each position in the order of B0 to B5 is confirmed, and a motion vector at a position with the same reference picture as a current block that is found first may be inserted into a motion vector prediction list as a motion vector prediction candidate. If there is no neighboring sample that has the same reference picture as a current block, a motion vector prediction candidate may be derived based on an available vector found first. Specifically, after scaling an available motion vector found first, a scaled motion vector may be inserted into a motion vector prediction list as a motion vector prediction candidate. In this case, scaling may be performed based on an output order difference between a current picture and a reference picture (i.e., a POC difference) and an output order difference between a current picture and a reference picture of a neighboring sample (i.e., a POC difference).

As in an example described above, a motion vector prediction candidate may be derived from a sample adjacent to the left of a current block, and a motion vector prediction candidate may be derived from a sample adjacent to the top of a current block.

In this case, a motion vector prediction candidate derived from a left sample may be inserted into a motion vector prediction list before a motion vector prediction candidate derived from a top sample. In this case, an index allocated to a motion vector prediction candidate derived from a left sample may have a smaller value than a motion vector prediction candidate derived from a top sample.

Conversely, a motion vector prediction candidate derived from a top sample may be inserted into a motion vector prediction list before a motion vector prediction candidate derived from a left sample.

Among the motion vector prediction candidates included in the motion vector prediction list, a motion vector prediction candidate with the highest encoding efficiency may be set as a motion vector predictor (MVP) of a current block. And, index information indicating a motion vector prediction candidate set as a motion vector prediction value of a current block among a plurality of motion vector prediction candidates may be encoded and signaled to a decoder. When the number of motion vector prediction candidates is 2, the index information may be a 1-bit flag (e.g., a MVP flag). In addition, a motion vector difference (MVD), which is a difference between a motion vector of a current block and a motion vector predictor, may be encoded and signaled to a decoder.

A decoder may configure a motion vector prediction list in the same manner as an encoder. In addition, index information may be decoded from a bitstream, and one of a plurality of motion vector prediction candidates may be selected based on decoded index information. A selected motion vector prediction candidate may be set as a motion vector prediction value of a current block.

In addition, a motion vector difference value may be decoded from a bitstream. Afterwards, a motion vector of a current block may be derived by combining a motion vector prediction value and a motion vector difference value.

When bidirectional prediction is applied to a current block, a motion vector prediction list may be generated for each of a L0 direction and a L1 direction. In other words a motion vector prediction list may be composed of motion vectors in the same direction. Accordingly, a motion vector of a current block and motion vector prediction candidates included in a motion vector prediction list have the same direction.

When a motion vector prediction mode is selected, a reference picture index and prediction direction information may be explicitly encoded and signaled to a decoder. As an example, when there are a plurality of reference pictures on a reference picture list and motion estimation is performed for each of a plurality of reference pictures, a reference picture index for specifying a reference picture where motion information of a current block is derived among the plurality of reference pictures may be explicitly encoded and signaled to a decoder.

In this case, when only one reference picture is included in a reference picture list, the encoding/decoding of the reference picture index may be omitted.

Prediction direction information may be an index indicating one of L0 unidirectional prediction, L1 unidirectional prediction, or bidirectional prediction. Alternatively, a L0 flag showing whether prediction for a L0 direction is performed and a L1 flag showing whether prediction for a L1 direction is performed may be encoded and signaled, respectively.

A motion information merge mode is a mode that sets the motion information of a current block to be the same as the motion information of a neighboring block. In a motion information merge mode, motion information may be decoded/encoded by using a motion information merge list.

A motion information merge candidate may be derived based on the motion information of a neighboring block or a neighboring sample adjacent to a current block. As an example, after pre-defining a reference position around a current block, whether motion information exists at a pre-defined reference position may be confirmed. When motion information exists at a pre-defined reference position, motion information at a corresponding position may be inserted into a motion information merge list as a motion information merge candidate.

In an example of FIG. 6, a pre-defined reference position may include at least one of A0, A1, B0, B1, B5 and Col. Furthermore, a motion information merge candidate may be derived in the order of A1, B1, B0, A0, B5 and Col.

Among the motion information merge candidates included in a motion information merge list, the motion information of a motion information merge candidate having an optimal cost may be set as the motion information of a current block. Furthermore, index information (e.g., a merge index) indicating a motion information merge candidate selected among a plurality of motion information merge candidates may be encoded and transmitted to a decoder.

In a decoder, a motion information merge list may be configured in the same way as in an encoder. And, a motion information merge candidate may be selected based on a merge index decoded from a bitstream. The motion information of a selected motion information merge candidate may be set as the motion information of a current block.

Unlike a motion vector prediction list, a motion information merge list is configured as a single list regardless of a prediction direction. In other words, a motion information merge candidate included in a motion information merge list may have only L0 motion information or L1 motion information, or may have bidirectional motion information (i.e., L0 motion information and L1 motion information).

A reconstructed sample region around a current block may be used to derive the motion information of a current block. Here, a reconstructed sample region used to derive the motion information of a current block may also be called a template.

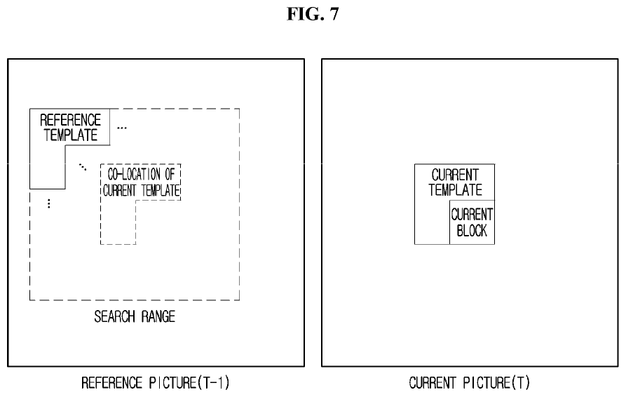

FIG. 7 is a diagram for describing a template-based motion estimation method.

In FIG. 3, it was described that a prediction block of a current block is determined based on a cost between a current block and a reference block within a search range. According to this embodiment, unlike FIG. 3, motion estimation for a current block may be performed based on a cost between a template neighboring a current block (hereinafter, referred to as a current template) and a reference template having the same size and shape as a current template.

As an example, a cost may be calculated based on a SAD of a difference value between reconstructed samples in a current template and reconstructed samples in a reference block. As a SAD is smaller, a cost may be reduced.

When a current template in a search range and a reference template having an optimal cost are determined, a reference block neighboring a reference template may be set as a prediction block of a current block.

And, the motion information of a current block may be set based on a distance between a current block and a reference block, an index of a picture to which a reference block belongs, and whether a reference picture is included in a L0 or L1 reference picture list.

Since a pre-reconstructed region around a current block is defined as a template, a decoder itself may perform motion estimation in the same manner as an encoder. Accordingly, when motion information is derived by using a template, there is no need to encode and signal motion information other than information representing whether to use a template.

A current template may include at least one of a region adjacent to the top of a current block or a region adjacent to the left of a current block. In this case, a region adjacent to the top may include at least one row, and a region adjacent to the left may include at least one column.

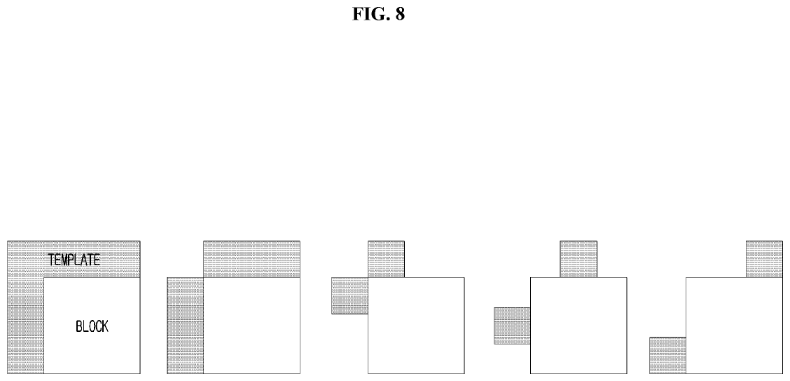

FIG. 8 shows examples in which a template is configured.

A current template may be configured according to one of the examples shown in FIG. 8.

Alternatively, unlike an example shown in FIG. 8, a template may be configured only with regions adjacent to the left of a current block, or a template may be configured only with regions adjacent to the top of a current block.

A size and/or a shape of a current template may be predefined in an encoder and a decoder.

Alternatively, after pre-defining a plurality of template candidates having a different size and/or shape, index information specifying one of a plurality of template candidates may be encoded and signaled to a decoder.

Alternatively, one of a plurality of template candidates may be adaptively selected based on at least one of a size, a shape or a position of a current block. As an example, when a current block adjoins a top boundary of a CTU, a current template may be configured only with regions adjacent to the left of a current block.

Template-based motion estimation may be performed on each reference picture stored in a reference picture list. Alternatively, motion estimation may be performed on only some of the reference pictures. As an example, motion estimation may be performed only for a reference picture whose reference picture index is 0, or motion estimation may be performed only for reference pictures whose reference picture index is less than a threshold value or reference pictures whose POC difference with a current picture is less than a threshold value.

Alternatively, motion estimation may be performed only for a reference picture indicated by the reference picture index after explicitly encoding and signaling a reference picture index.

Alternatively, motion estimation may be performed for a reference picture of a neighboring block corresponding to a current template. As an example, if a template is composed of a left adjacent region and a top adjacent region, at least one reference picture may be selected by using at least one of a reference picture index of a left neighboring block or a reference picture index of a top neighboring block. Afterwards, motion estimation may be performed for at least one selected reference picture.

Information representing whether template-based motion estimation is applied may be encoded and signaled to a decoder. The information may be a 1-bit flag. As an example, when the flag is true (1), it indicates that template-based motion estimation is applied to a L0 direction and a L1 direction of a current block. On the other hand, when the flag is false (0), it indicates that template-based motion estimation is not applied. In this case, motion information of a current block may be derived based on a motion information merge mode or a motion vector prediction mode.

Conversely, only when it is determined that a motion information merge mode and a motion vector prediction mode are not applied to a current block, template-based motion estimation may be applied. As an example, when both a first flag representing whether a motion information merge mode is applied and a second flag representing whether a motion vector prediction mode is applied are 0, template-based motion estimation may be performed.

Information representing whether template-based motion estimation is applied may be signaled for each of a L0 direction and a L1 direction. In other words, whether template-based motion estimation is applied to a L0 direction and whether template-based motion estimation is applied to a L1 direction may be determined independently. Accordingly, template-based motion estimation may be applied to any one of a L0 direction and a L1 direction, while a different mode (e.g., a motion information merge mode or a motion vector prediction mode) may be applied to the other.

When template-based motion estimation is applied to both a L0 direction and a L1 direction, a prediction block of a current block may be generated based on the weighted sum operation of a L0 prediction block and a L1 prediction block. Alternatively, even when template-based motion estimation is applied to one of a L0 direction and a L1 direction, but a different mode is applied to the other, a prediction block of a current block may be generated based on the weighted sum operation of a L0 prediction block and a L1 prediction block. It will be described later through Equation 2.

Alternatively, a template-based motion estimation method may be inserted as a motion information merge candidate on a motion information merge mode or a motion vector prediction candidate on a motion vector prediction mode. In this case, whether to apply a template-based motion estimation method may be determined based on whether a selected motion information merge candidate or a selected motion vector prediction candidate indicates a template-based motion estimation method.

Based on a bilateral matching method, the motion information of a current block may also be generated.

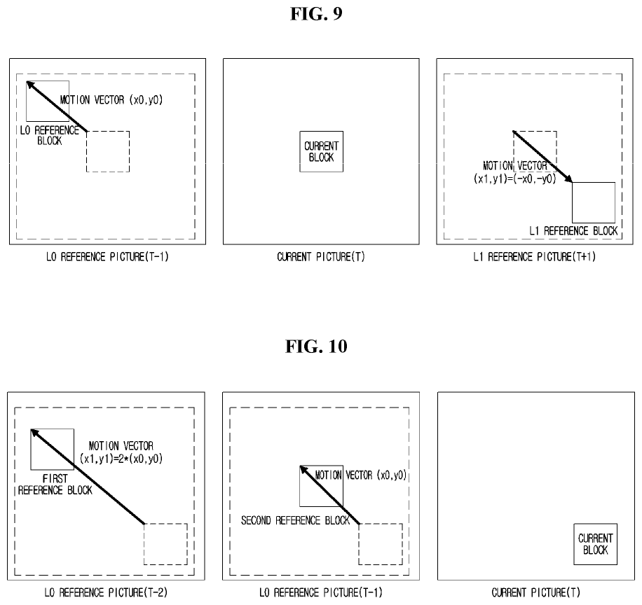

FIG. 9 is a diagram for describing a motion estimation method based on a bilateral matching method.

A bilateral matching method may be performed only when the temporal order (i.e., POC) of a current picture exists between the temporal order of a L0 reference picture and the temporal order of a L1 reference picture.

When a bilateral matching method is applied, a search range may be set for each of a L0 reference picture and a L1 reference picture. In this case, a L0 reference picture index for identifying a L0 reference picture and a L1 reference picture index for identifying a L1 reference picture may be encoded and signaled, respectively.

As another example, only a L0 reference picture index may be encoded and signaled, and a L1 reference picture may be selected based on a distance between a current picture and a L0 reference picture (hereinafter, referred to as a L0 POC difference). As an example, among the L1 reference pictures included in a L1 reference picture list, a L1 reference picture that an absolute value of a distance with a current picture (hereinafter, referred to as a L1 POC difference) is the same as an absolute value of a distance between a current picture and a L0 reference picture may be selected. When there is no L1 reference picture having the same L1 POC difference as a L0 POC difference, a L1 reference picture that a L1 POC difference is most similar to a L0 POC difference may be selected among the L1 reference pictures.

In this case, only a L1 reference picture whose temporal direction is different from that of a L0 reference picture among the L1 reference pictures may be used for bilateral matching. As an example, when a POC of a L0 reference picture is smaller than that of a current picture, one of the L1 reference pictures whose POC is larger than that of a current picture may be selected.

Conversely, only a L1 reference picture index may be encoded and signaled, and a L0 reference picture may be selected based on a distance between a current picture and a L1 reference picture.

Alternatively, a bilateral matching method may be performed by using a L0 reference picture closest to a current picture among the L0 reference pictures and a L1 reference picture closest to a current picture among the L1 reference pictures.

Alternatively, a bilateral matching method may be performed by using a L0 reference picture (e.g., index 0) to which a predefined index in a L0 reference picture list is allocated and a L1 reference picture (e.g., index 0) to which a predefined index in a L1 reference picture list is allocated.

Alternatively, a LX (X is 0 or 1) reference picture may be selected based on an explicitly signaled reference picture index, and a L |X−1| reference picture may be selected as a reference picture closest to a current picture among the L |X−1| reference pictures or a reference picture having a predefined index in a L |X−1| reference picture list.

As another example, L0 and/or L1 reference pictures may be selected based on the motion information of a neighboring block of a current block. As an example, L0 and/or L1 reference pictures to be used for bilateral matching may be selected by using a reference picture index of a left or top neighboring block of a current block.

A search range may be set within a predetermined range from a col-located block in a reference picture.

As another example, a search range may be set based on initial motion information. Initial motion information may be derived from a neighboring block of a current block. As an example, the motion information of a left neighboring block or a top neighboring block of a current block may be set as the initial motion information of a current block.

When a bilateral matching method is applied, a L0 motion vector and a motion vector in a L1 direction are set in an opposite direction. It represents that a sign of a L0 motion vector is opposite to a sign of a motion vector in a L1 direction. In addition, a size of a LX motion vector may be proportional to a distance between a current picture and a LX reference picture (i.e., a POC difference).

Afterwards, motion estimation may be performed by using a cost between a reference block belonging to a search range of a L0 reference picture (hereinafter, referred to as a L0 reference block) and a reference block belonging to a search range of a L1 reference picture (hereinafter, referred to as a L1 reference block).

When a L0 reference block that a vector with a current block is (x, y) is selected, a L1 reference block at a position spaced by (−Dx, −Dy) from a current block may be selected. Here, D may be determined by a ratio of a distance between a current picture and a L0 reference picture and a distance between a L1 reference picture and a current picture.

As an example, in an example shown in FIG. 9, an absolute value of a distance between a current picture (T) and a L0 reference picture (T−1) is mutually the same as an absolute value of a distance between a current picture (T) and a L1 reference picture (T+1). Accordingly, in a shown example, a L0 motion vector (x0, y0) and a L1 motion vector (x1, y1) have the same size, but an opposite distance. If a L1 reference picture that a POC is (T+2) is used, a L1 motion vector (x1, y1) will be set as (−2*x0, −2*y0).

When a L0 reference block and a L1 reference block having an optimal cost are selected, each of a L0 reference block and a L1 reference block may be set as a L0 prediction block and a L1 prediction block of a current block. Afterwards, a final prediction block of a current block may be generated through a weighted sum operation of a L0 reference block and a L1 reference block. As an example, according to Equation 2 described later, a prediction block of a current block may be generated.

When a bilateral matching method is applied, a decoder may perform motion estimation in the same manner as an encoder. Accordingly, information representing whether a bilateral motion matching method is applied may be explicitly encoded/decoded, while decoding/encoding of motion information such as a motion vector, etc. may be omitted. As described above, at least one of a L0 reference picture index or a L1 reference picture index may be explicitly encoded/decoded.

As another example, when information representing whether a bilateral matching method is applied is explicitly encoded/decoded, but a bilateral matching method is applied, a L0 motion vector or a L1 motion vector may be explicitly encoded and signaled. When a L0 motion vector is signaled, a L1 motion vector may be derived based on a POC difference between a current picture and a L0 reference picture and a POC difference between a current picture and a L1 reference picture. When a L1 motion vector is signaled, a L0 motion vector may be derived based on a POC difference between a current picture and a L0 reference picture and a POC difference between a current picture and a L1 reference picture. In this case, an encoder may explicitly encode the smaller one between a L0 motion vector and a L1 motion vector.

Information representing whether a bilateral matching method is applied may be a 1-bit flag. As an example, when the flag is true (e.g., 1), it may represent that a bilateral matching method is applied to a current block. When the flag is false (e.g., 0), it may represent that a bilateral matching method is not applied to a current block. In this case, a motion information merge mode or a motion vector prediction mode may be applied to a current block.

Conversely, a bilateral matching method may be applied only when it is determined that a motion information merge mode and a motion vector prediction mode are not applied to a current block. As an example, when both a first flag representing whether a motion information merge mode is applied and a second flag representing whether a motion vector prediction mode is applied are 0, a bilateral matching method may be applied.

Alternatively, a bilateral matching method may be inserted as a motion information merge candidate on a motion information merge mode or a motion vector prediction candidate on a motion vector prediction mode. In this case, whether to apply a bilateral matching method may be determined based on whether a selected motion information merge candidate or a selected motion vector prediction candidate indicates a bilateral matching method.

In a bilateral matching method, it was illustrated that the temporal order of a current picture must exist between the temporal order of a L0 reference picture and the temporal order of a L1 reference picture. A unidirectional matching method to which a constraint of the bilateral matching method is not applied may be applied to generate a prediction block of a current block. Specifically, in a unidirectional matching method, two reference pictures having temporal order smaller than that of a current block (i.e., a POC) or two reference pictures having temporal order larger than that of a current block may be used. In this case, two reference pictures may be derived from a L0 reference picture list or a L1 reference picture list. Alternatively, one of the two reference pictures may be derived from a L0 reference picture list and the other may be derived from a L1 reference picture list.

FIG. 10 is a diagram for describing a motion estimation method based on a unidirectional matching method.

A unidirectional matching method may be performed based on two reference pictures with a POC smaller than that of a current picture (i.e., forward reference pictures) or two reference pictures with a POC larger than that of a current picture (i.e., backward reference pictures). In FIG. 10, it was illustrated that motion estimation based on a unidirectional matching method is performed based on a first reference picture (T−1) and a second reference picture (T−2) with a POC smaller than that of a current picture (T).

In this case, a first reference picture index for identifying a first reference picture and a second reference picture index for identifying a second reference picture may be encoded and signaled, respectively. In this case, among the two reference pictures used for a unidirectional matching method, a reference picture having a smaller POC difference from a current picture may be set as a first reference picture. Accordingly, when a first reference picture is selected, only reference pictures whose POC difference from a current picture is larger than that from a first reference picture among the reference pictures included in a reference picture list may be set as a second reference picture. A second reference picture index may be set to indicate an index of one of the reordered reference pictures after reordering reference pictures that have the same temporal direction as a first reference picture and have a larger POC difference from a current picture than that from a first reference picture.

Conversely, among the two reference pictures, a reference picture having a larger POC difference from a current picture may be set as a first reference picture. In this case, a second reference picture index may be set to indicate an index of one of the reordered reference pictures after reordering reference pictures that have the same temporal direction as a first reference picture and have a smaller POC difference from a current picture than that from a first reference picture.

Alternatively, a unidirectional matching method may be performed by using a reference picture to which a predefined index is allocated in a reference picture list and a reference picture having the same temporal direction. As an example, a reference picture having an index of 0 in a reference picture list may be set as a first reference picture, and a reference picture having the smallest index among the reference pictures having the same temporal direction as a first reference picture in a reference picture list may be selected as a second reference picture.

Both a first reference picture and a second reference picture may be selected from a L0 reference picture list or a L1 reference picture list. In FIG. 10, it was shown that two L0 reference pictures are used for a unidirectional matching method. Alternatively, a first reference picture may be selected from a L0 reference picture list, and a second reference picture may be selected from a L1 reference picture list.

Information representing whether a first reference picture and/or a second reference picture belong to a L0 reference picture list or a L1 reference picture list may be additionally encoded/decoded.

Alternatively, unidirectional matching may be performed by using one set as default among a L0 reference picture list and a L1 reference picture list. Alternatively, two reference pictures may be selected from one with a larger number of reference pictures among a L0 reference picture list and a L1 reference picture list.

Afterwards, a search range within a first reference picture and a second reference picture may be set.

A search range may be set within a predetermined range from a collocated block in a reference picture.

As another example, a search range may be set based on initial motion information. Initial motion information may be derived from a neighboring block of a current block. As an example, the motion information of a left neighboring block or a top neighboring block of a current block may be set as the initial motion information of a current block.

Afterwards, motion estimation may be performed by using a cost between a first reference block belonging to a search range of a first reference picture and a second reference block belonging to a search range of a second reference picture.

In this case, under a unidirectional matching method, a size of a motion vector should be set to increase in proportion to a distance between a current picture and a reference picture. Specifically, when a first reference block whose vector with a current picture is (x, y) is selected, a second reference block should be separated from a current block by (Dx, Dy). Here, D may be determined by a ratio of a distance between a current picture and a first reference picture and a distance between a current picture and a second reference picture.

As an example, in an example of FIG. 10, a distance between a current picture and a first reference picture (i.e., a POC difference) is 1, and a distance between a current picture and a second reference picture (i.e., a POC difference) is 2. Accordingly, when a first motion vector for a first reference block in a first reference picture is (x0, y0), a second motion vector (x1, y1) for a second reference block in a second reference picture may be set as (2x0, 2y0).

When a first reference block and a second reference block having an optimal cost are selected, each of a first reference block and a second reference block may be set as a first prediction block and a second prediction block of a current block. Afterwards, a final prediction block of a current block may be generated through a weighted sum operation of a first prediction block and a second prediction block. As an example, according to Equation 2 described later, a prediction block of a current block may be generated.

When a unidirectional matching method is applied, a decoder may perform motion estimation in the same manner as an encoder. Accordingly, information representing whether a unidirectional motion matching method is applied may be explicitly encoded/decoded, while encoding/decoding of motion information such as a motion vector, etc. may be omitted. As described above, at least one of a first reference picture index or a second reference picture index may be explicitly encoded/decoded.

As another example, when information representing whether a unidirectional matching method is applied is explicitly encoded/decoded and a unidirectional matching method is applied, a first motion vector or a second motion vector may be explicitly encoded and signaled. When a first motion vector is signaled, a second motion vector may be derived based on a POC difference between a current picture and a first reference picture and a POC difference between a current picture and a second reference picture. When a second motion vector is signaled, a first motion vector may be derived based on a POC difference between a current picture and a first reference picture and a POC difference between a current picture and a second reference picture. In this case, an encoder may explicitly encode the smaller one among a first motion vector and a second motion vector.

Information representing whether a unidirectional matching method is applied may be a 1-bit flag. As an example, when the flag is true (e.g., 1), it may represent that a unidirectional matching method is applied to a current block. When the flag is false (e.g., 0), it may represent that a unidirectional matching method is not applied to a current block. In this case, a motion information merge mode or a motion vector prediction mode may be applied to a current block.

Conversely, a unidirectional matching method may be applied only when it is determined that a motion information merge mode and a motion vector prediction mode are not applied to a current block. As an example, when both a first flag showing whether a motion information merge mode is applied and a second flag showing whether a motion vector prediction mode is applied are 0, a unidirectional matching method may be applied.

Alternatively, a unidirectional matching method may be inserted as a motion information merge candidate in a motion information merge mode or a motion vector prediction candidate in a motion vector prediction mode. In this case, whether a unidirectional matching method is applied may be determined based on whether a selected motion information merge candidate or a selected motion vector prediction candidate indicates a unidirectional matching method.

The precision of a motion vector may also be adjusted to search for an inter motion of an object. Specifically, a position of each pixel in a picture is specified as an integer. On the other hand, an inter motion of an object may not be expressed as an integer position.

Considering this, interpolation may be performed on a reference picture to search for a motion vector in a unit of a fractional pixel.

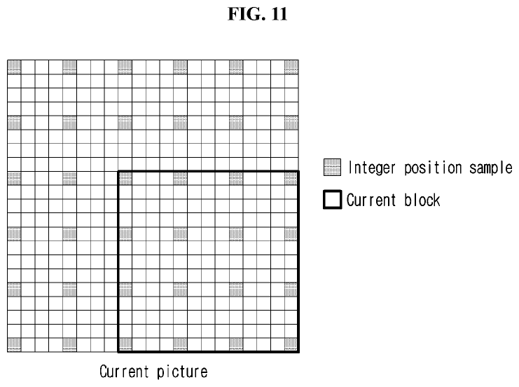

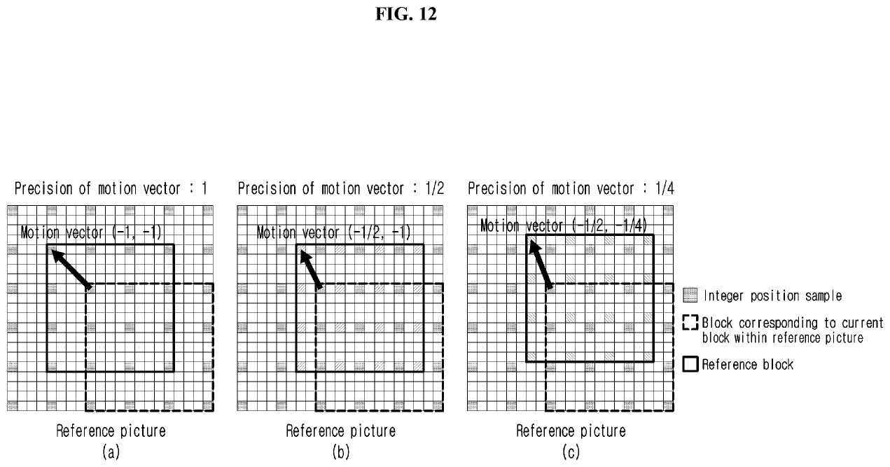

FIGS. 11 and 12 show an example in which a prediction block is generated according to the precision of a motion vector.

FIG. 11 shows a position of a current block in a current picture, and FIG. 12 shows an example in which a prediction block is obtained according to a motion vector.

Specifically, FIG. 12(a) shows an example in which motion vector precision is in a unit of an integer pixel, and FIGS. 12(b) and (c) show an example in which motion vector precision is in a ½ pixel unit and in a ¼ pixel unit, respectively.

Motion vector precision may be set in a unit smaller than shown. As an example, motion vector precision may be set in a ⅛ pixel unit, a 1/16 pixel unit or a 1/32 pixel unit.

When a motion vector of a current block is expressed in an integer unit, as in an example shown in FIG. 12(a), a reference block composed of integer position samples may be set as a prediction block of a current block.

On the other hand, when a motion vector of a current block is expressed in a fractional unit, as in an example shown in FIGS. 12(b) and (c), a reference block composed of fractional position samples may be set as a prediction block of a current block. In this case, a fractional position sample in a reference block may be generated by interpolating integer position samples. An interpolation filter may have a size of 4 taps or 8 taps.

As another example, in order to reduce complexity, a fractional position sample may be generated through linear interpolation using only integer position samples adjacent to a fractional position.

Information indicating the motion vector precision of a current block may be encoded and signaled. As an example, after allocating a different index to each of a plurality of motion vector precision candidates, an index of a motion vector precision candidate corresponding to the motion vector precision of a current block may be encoded and signaled.

In this case, the number and/or type of available motion vector candidates may be determined based on at least one of a size of a current block, a shape of a current block, a reference picture or a motion compensation model. Here, a motion compensation model may include at least one of a translation model, a zooming model or a rotation model. A motion compensation model that at least one of a zooming model or a rotation model is combined with a translation model may be referred to as an affine model.

An index indicating one of the motion vector candidates available for a current block may be encoded. The maximum number of bits required to encode an index may be determined according to the number of motion vector candidates available for a current block.

The precision of a motion vector may be adjusted to search for a motion vector more precisely, and accordingly, prediction accuracy for a current block may be improved.

Meanwhile, a motion vector expressed as a fractional position may be scaled up to an integer and encoded.

Compensation for a motion of an object may be performed based on at least one of a translation model for compensating for a linear motion of an object (e.g., a motion in a horizontal and/or vertical direction), a zooming model for compensating for a size change of an object and a rotation model for compensating for a rotational motion of an object. Here, zooming may represent size enlargement or size reduction.

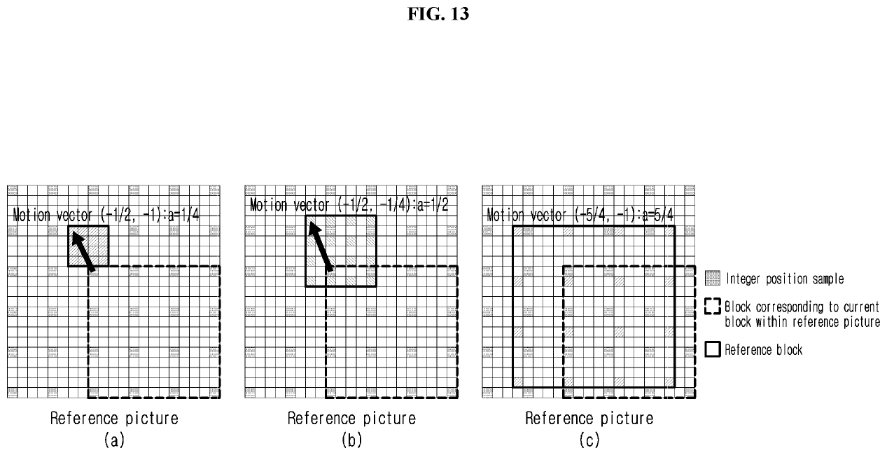

FIG. 13 represents an example in which motion compensation based on a translation model and a zooming model is performed for a current block.

For convenience of a description, it is assumed that a current block has a size of 4×4, as shown in FIG. 11.

In FIG. 13, variable a represents a size adjustment parameter. A size of a reference block may be derived by multiplying a size of a current block by variable a.

When size adjustment parameter a is less than 1, it represents that a reference block is smaller than a current block, and when size adjustment parameter a is greater than 1, it represents that a reference block is larger than a current block.

FIGS. 13(a) and (b) show an example of a case in which size adjustment parameter a is less than 1, and FIG. 13(c) shows an example of a case in which size adjustment parameter a is greater than 1.

Based on a motion vector of a current block, a top-left position of a reference block may be specified. Specifically, a position separated by a motion vector from a position corresponding to a top-left sample of a current block in a reference picture may be set as a top-left position of a reference block. Afterwards, according to a size adjustment parameter, a reference block whose width and height are a times a width and a height of a current block, respectively, may be set. A fractional position sample in a reference block may be generated by interpolating integer position samples.

A reference block derived by a motion vector and a size adjustment parameter may be set as a prediction block of a current block.

Meanwhile, information about size adjustment parameter a may be encoded and signaled. Specifically, a different index may be allocated to each of a plurality of size adjustment parameter candidates, and an index specifying a size adjustment parameter candidate applied to a current block may be encoded and signaled.

Alternatively, a size adjustment parameter of a current block may be derived based on a size adjustment parameter of a neighboring block. As an example, a size adjustment parameter of a neighboring block at a predefined position may be set as a size adjustment parameter of a current block.

Alternatively, when a plurality of neighboring blocks are sequentially searched, a size adjustment parameter of an available neighboring block searched first may be set as a size adjustment parameter of a current block.

Alternatively, a size adjustment parameter of a neighboring block may be set as a size adjustment parameter candidate. In this case, a plurality of neighboring blocks may be sequentially searched to generate a size adjustment parameter candidate list including a plurality of size adjustment parameter candidates. One of a plurality of size adjustment parameter candidates included in a plurality of size adjustment parameter candidate lists may be set as a size adjustment parameter of a current block. In this case, an index indicating the same candidate as a size adjustment parameter of a current block among a plurality of size adjustment parameter candidates may be encoded and signaled.

Meanwhile, a neighboring block used to derive a size adjustment parameter of a current block may include at least one of a top neighboring block, a left neighboring block, a top-left neighboring block, a top-right neighboring block or a bottom-left neighboring block.

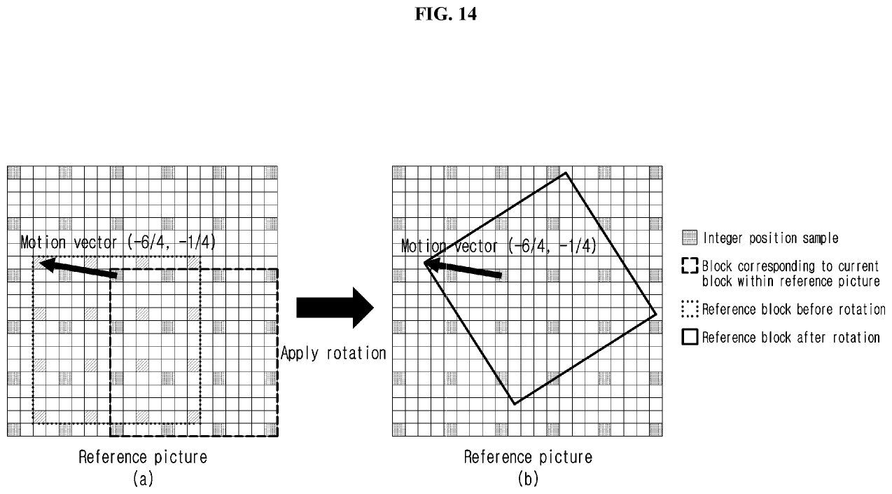

FIG. 14 represents an example in which motion compensation based on a translation model and a rotation model is performed for a current block.

For convenience of a description, it is assumed that a current block has a size of 4×4, as shown in FIG. 11.

First, as in an example shown in FIG. 14(a), a position of a temporary block in a reference picture may be specified based on a motion vector of a current block. Specifically, a block position that takes a position separated by a motion vector from a position corresponding to a top-left sample of a current block in a reference picture as a top-left sample may be specified.

Afterwards, as in an example shown in FIG. 14(b), a temporary block may be rotated. A block at a rotated position may be set as a reference block, and a reference block may be set as a prediction block of a current block.

Meanwhile, a rotation matrix may be used to rotate a temporary block specified by a motion vector. In other words, a prediction sample for a current block may be set as a sample at a position obtained by applying a rotation matrix to a sample position in a temporary block.

Equation 1 represents a rotation matrix.

$$[ {pos\_x}^{′} , {pos\_y}^{′} ] = [ pos\_x , pos\_y ] [ \begin{matrix}cos θ & - sin θ \\ sin θ & cos θ\end{matrix} ] \qquad [ Equation 1 ]$$

In Equation 1 above, (pos_x, pos_y) represents a position of a sample within a temporary block. In other words, (pos_x, pos_y) may be derived by adding a motion vector to a position of a prediction target sample in a current block.

(pos_x′, pos_y′) represents a position rotated from a position of a sample in a temporary block, and θ refers to a rotation angle.

A sample value at a position of (pos_x′, pos_y′) in a reference picture may be set as a value of a prediction sample for a position of a prediction target sample. When a position of (pos_x′, pos_y′) is a fractional position, a sample at a corresponding position may be generated by interpolating integer position samples.

Meanwhile, information showing rotation angle θ may be encoded and signaled. As an example, after allocating a different index to each of a plurality of rotation angle candidates, an index of a rotation angle candidate corresponding to a rotation angle of a current block may be encoded and signaled.

Alternatively, a rotation angle of a current block may be derived based on a rotation angle of a neighboring block. As an example, a rotation angle of a neighboring block at a predefined position may be set as a rotation angle of a current block.

Alternatively, when searching a plurality of neighboring blocks sequentially, a rotation angle of an available neighboring block searched first may be set as a rotation angle of a current block.

Alternatively, a rotation angle of a neighboring block may be set as a rotation angle candidate. In this case, a rotation angle candidate list including a plurality of rotation angle candidates may be generated by searching a plurality of neighboring blocks sequentially. One of a plurality of rotation angle candidates included in a plurality of rotation angle candidate lists may be set as a rotation angle of a current block. In this case, an index indicating the same candidate as a rotation angle of a current block among a plurality of rotation angle candidates may be encoded and signaled.

Meanwhile, a neighboring block used to derive a rotation angle of a current block may include at least one of a top neighboring block, a left neighboring block, a top-left neighboring block, a top-right neighboring block or a bottom-left neighboring block.

Although not shown, motion compensation for a current block may be performed by simultaneously applying a translation model, a zooming model and a rotation model.

Meanwhile, the number and/or type of motion vector precision candidates available for a current block or motion vector precision for a current block may be determined differently according to a motion compensation model.

As an example, the number and/or type of motion vector precision candidates available for a current block may be different between a case in which only a translation model is applied and a case in which at least one of a zooming model or a rotation model is applied.

As a specific example, when a translation model is applied to a current block, candidates in a ¼ pixel unit or higher may be available for a current block. On the other hand, when at least one of a zooming model or a rotation model is additionally applied to a current block along with a translation model, candidates in a 1/16 pixel unit or higher may be available for a current block.

Alternatively, when a translation model is applied to a current block, the motion vector precision of a current block may be set in a ¼ pixel unit. On the other hand, when at least one of a zooming model or a rotation model is additionally applied to a current block along with a translation model, the motion vector precision of a current block may be set in a 1/16 pixel unit.

Meanwhile, in an encoder and a decoder, available motion vector precision or available motion vector precision candidates for each motion compensation model may be pre-stored. Alternatively, information representing available motion vector precision or available motion vector precision candidates for each motion compensation model may be encoded and signaled through a higher header.

A motion vector of a control point may be used to perform motion compensation for an affine model that a zooming model and/or a rotation model are added to a translation model. Here, a control point may correspond to a corner of a current block. As an example, in order to perform motion compensation based on an affine model, at least one of a motion vector at a top-left corner, a motion vector at a top-right corner or a motion vector at a bottom-left corner may be used.

Hereinafter, a motion vector of a control point is referred to as a control point motion vector.

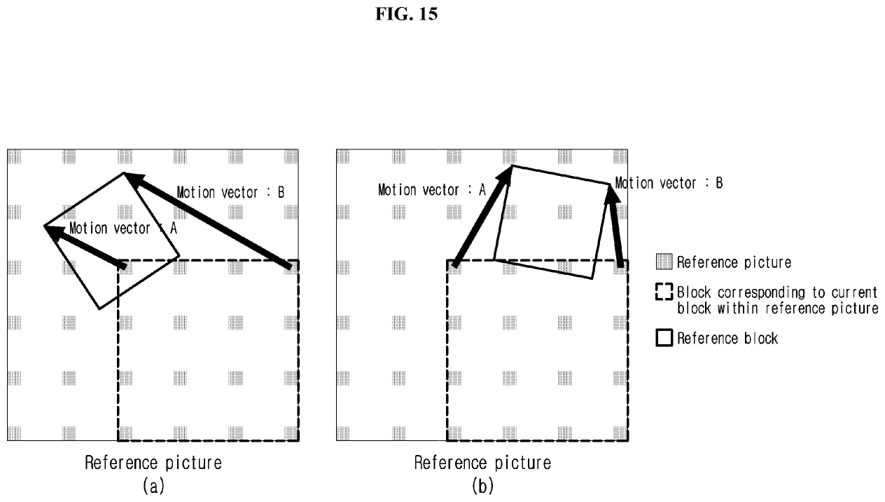

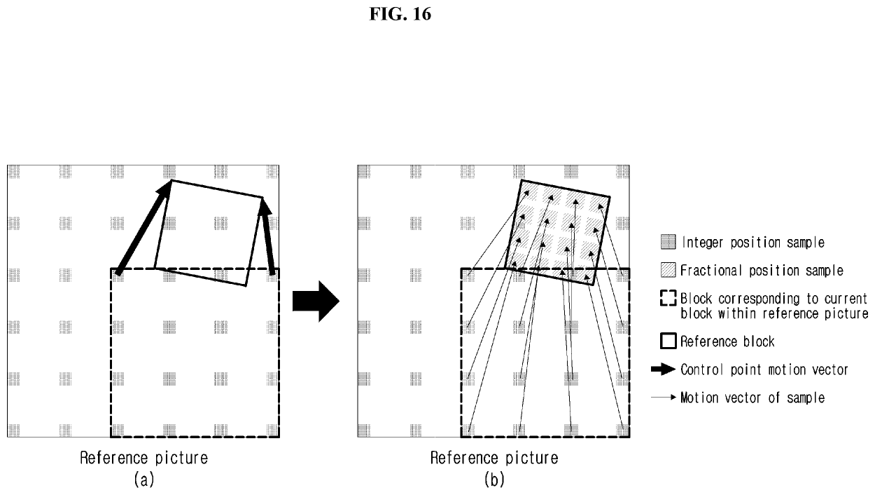

FIGS. 15 and 16 represent an example in which a prediction block for a current block is generated by using control point motion vectors.

For convenience of a description, it is assumed that a current block has a size of 4×4, as shown in FIG. 11.

In FIGS. 15(a) and (b), it was illustrated that a prediction block for a current block is derived by a motion vector of a first control point corresponding to a top-left corner of a current block (a first control point motion vector, A) and a motion vector of a second control point corresponding to a top-right corner of a current block (a second control point motion vector, B).

In addition to a shown example, it is also possible to derive a prediction block of a current block by additionally using a motion vector at a bottom-left corner or by using a motion vector of a bottom-left corner instead of a top-right corner.

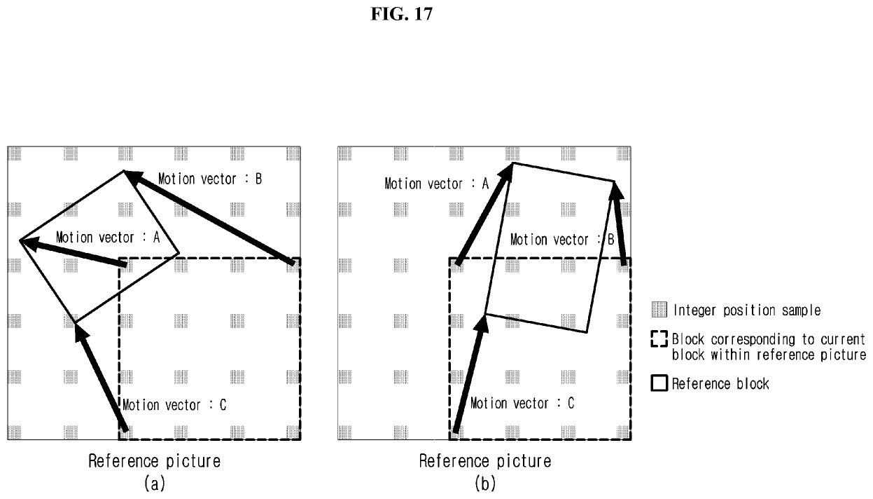

FIG. 17 represents an example in which a prediction block for a current block is generated by using three control point motion vectors.

In FIGS. 17(a) and (b), it was illustrated that a prediction block for a current block is derived by a motion vector of a first control point corresponding to a top-left corner of a current block (a first control point motion vector, A), a motion vector of a second control point corresponding to a top-right corner of a current block (a second control point motion vector, B) and a motion vector of a third control point corresponding to a bottom-left corner of a current block (a third control point motion vector, C).

As in an example shown in FIGS. 15 to 17, translation, zooming and rotation motion compensation for a current block may be performed by using two control point motion vectors or three control point motion vectors.

Information representing the number of control point motion vectors may be encoded and signaled. The information may be signaled in a unit of a block. As an example, the information may indicate whether two control point motion vectors or three control point motion vectors are used for a current block.

Alternatively, the number of control point motion vectors may be adaptively determined based on at least one of a size or a shape of a current block.

Alternatively, when the control point motion vectors of a current block are derived from a neighboring block, the number of control point motion vectors for a current block may be set to be the same as the number of control point motion vectors of a neighboring block.

A motion vector by sample in a current block may be derived by using control point motion vectors. Equation 2 represents a formula for deriving a motion vector per sample by using two control point motion vectors.

$${mv}_{x} = \frac{{mv}_{Bx} - {mv}_{Ax}}{W} x + \frac{{mv}_{By} - {mv}_{Ay}}{W} y + {mv}_{Ax} \qquad [ Equation 2 ]$$

$${mv}_{y} = \frac{{mv}_{By} - {mv}_{Ay}}{W} x + \frac{{mv}_{Bx} - {mv}_{Ax}}{W} y + {mv}_{Ay}$$

In Equation 2 above, (mvₓ, mv_{y}) represents a motion vector at a position of (x, y) within a current block. (mv_{Ax}, mv_{Ay}) represents a first control point motion vector (A), and (mv_{Bx}, mv_{By}) represents a second control point motion vector (B). W represents a width of a current block.

When three control point motion vectors are used, a motion vector by sample may be derived by Equation 3 below.

$${mv}_{x} = \frac{{mv}_{Bx} - {mv}_{Ax}}{W} x + \frac{{mv}_{Cx} - {mv}_{Ax}}{W} y + {mv}_{Ax} \qquad [ Equation 3 ]$$

$${mv}_{y} = \frac{{mv}_{By} - {mv}_{Ay}}{W} x + \frac{{mv}_{Cy} - {mv}_{Ay}}{W} y + {mv}_{Ay}$$

In Equation 3 above, (mv_{Cx}, mv_{Cy}) represents a third control point motion vector (C).

When a motion vector is derived per sample, as in an example shown in FIG. 16, motion compensation for each sample may be performed. Specifically, a reference sample indicated by a motion vector of a prediction target sample may be set as a prediction sample for a prediction target sample.

Meanwhile, when a motion vector of a prediction target sample is expressed in a fractional unit, integer position samples may be interpolated to generate a fractional position sample, and a generated fractional position sample may be set as a prediction sample for a prediction target sample.

In this case, the precision of a motion vector for each sample may be different. As an example, a motion vector for a first prediction target sample may be derived in a ½ pixel unit, while a motion vector for a second prediction target sample may be derived in a ¼ pixel unit.

In this case, a fractional position sample may be generated according to motion vector precision for each prediction target sample. Alternatively, after adjusting a motion vector of a prediction target sample according to reference motion vector precision, a prediction sample for a prediction target sample may be derived based on an adjusted motion vector. As an example, when reference motion vector precision is ½, a motion vector for a second prediction target sample may be adjusted in a ¼ pixel unit.

Reference motion vector precision may be determined in a unit of a block. Alternatively, the precision of control point motion vectors may be set as reference motion vector precision. Alternatively, in an encoder and a decoder, reference motion vector precision may be predefined.

As another example, in order to reduce complexity, a motion vector may be derived in a unit of a sub-block.

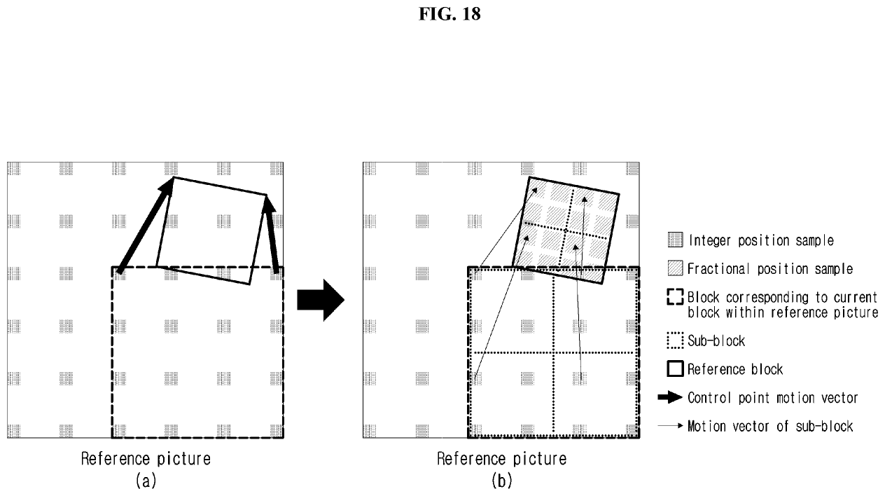

FIG. 18 represents an example in which a motion vector is derived in a unit of a sub-block.

A size and/or a shape of a sub-block may be predefined in an encoder and a decoder. As an example, a sub-block may be a 2×2 or 4×4-sized square block.

Alternatively, a size and/or a shape of a sub-block may be adaptively determined according to a size and/or a shape of a current block. As an example, when a current block is square, a sub-block may also be square. On the other hand, when a current block is non-square, a sub-block may also be non-square.

Alternatively, information on at least one of a partition method or a partition shape of a current block may be explicitly encoded and signaled. As an example, information on at least one of a size of a sub-block, a shape of a sub-block, a position of a partition line partitioning a current block or the number of partition lines may be explicitly encoded and signaled. The information may be encoded and signaled in a unit of a block, or may be encoded and signaled through a higher header.

In FIG. 18, it was assumed that a sub-block is a 2×2-sized square block.

A motion vector of a sub-block may be derived by using a coordinate at a predefined position within a sub-block. Here, a predefined position may be one of a position of a top-left sample, a position of a top-right sample, a position of a bottom-left sample, a position of a bottom-right sample or a center position within a sub-block.

A motion vector of a sub-block may be derived by substituting a coordinate at a predefined position within a sub-block into (x, y) in Equation 2.

As in an example described above, a motion vector may be derived in a unit of a sub-block based on an affine motion model.

Meanwhile, a motion vector may also be derived in a unit of a sub-block by using a collocated picture. As above, when a motion vector is derived in a unit of a sub-block by using a collocated picture, it may be referred to as Sub-block Temporal Motion Vector Prediction (SbTMVP).

A collocated picture may be one of the reference pictures included in a reference picture list. As an example, a picture with an index of 0 in a reference picture list may be selected as a collocated picture.

Alternatively, information indicating an index of a reference picture set as a collocated picture in a reference picture list may be explicitly encoded and signaled.

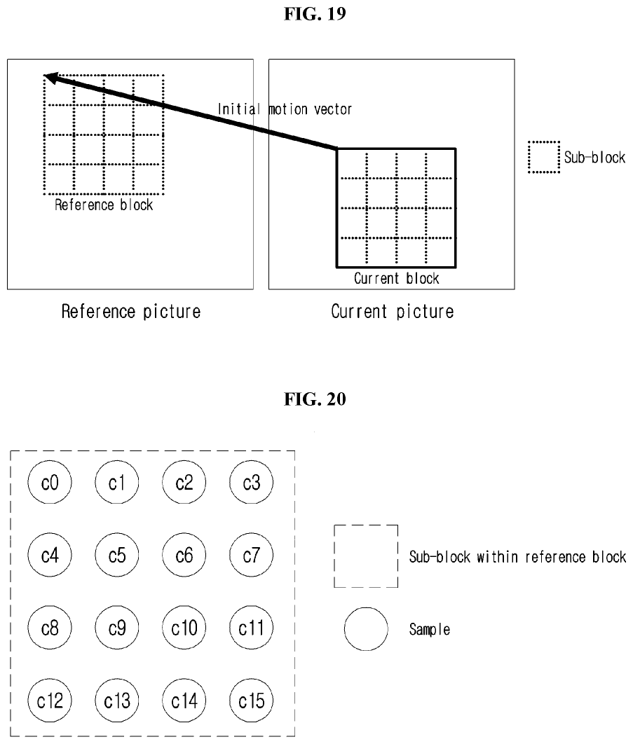

FIGS. 19 and 20 represent an example in which a motion vector is derived in a unit of a sub-block within a current block when SbTMVP is applied.

A size and/or a shape of a sub-block may be predefined in an encoder and a decoder.

Alternatively, a size and/or a shape of a sub-block may be adaptively determined according to a size and/or a shape of a current block. As an example, when at least one of a width or a height of a current block is greater than a threshold value, a size of a sub-block may be set as 8×8. Otherwise, a size of a sub-block may be set as 4×4.

Alternatively, information indicating a size and/or a shape of a sub-block may be explicitly encoded and signaled.

In an example shown in FIG. 19, it is assumed that a size of a current block is 16×16 and a size of a sub-block is 4×4.

When SbTMVP is applied, an initial motion vector of a current block may be derived. An initial motion vector may be derived based on at least one of a motion vector prediction list or a motion information merge list. As an example, an index indicating one of the motion vector prediction candidates included in a motion vector prediction list may be encoded and signaled. An initial motion vector may be derived by adding a motion vector difference value to a motion vector prediction candidate indicated by the index. Meanwhile, a motion vector difference value may also be explicitly encoded and signaled.

Alternatively, encoding of an index may be omitted, and a motion vector prediction candidate having a predefined index in a motion vector prediction list may be set as a prediction value for an initial motion vector. Here, a motion vector prediction candidate having a predefined index may be a motion vector prediction candidate having an index of 0 or a motion vector prediction candidate having the largest index.

Alternatively, an index indicating one of the motion information merge candidates included in a motion information merge list may be encoded and signaled. An initial motion vector may be set to be the same as a motion vector of a motion information merge candidate indicated by the index.

Alternatively, encoding of an index may be omitted, and an initial motion vector may be derived based on a motion information merge candidate having a predefined index in a motion information merge list. Here, a motion information merge candidate having a predefined index may be a motion information merge candidate having an index of 0 or a motion information merge candidate having the largest index.

Alternatively, an initial motion vector may be derived by using a motion vector of a neighboring block at a predefined position. Here, a neighboring block at a predefined position may be a left neighboring block or a top neighboring block.

A motion vector of a neighboring block at a predefined position may be set as a prediction value of an initial motion vector and a difference value may be added to the prediction value, deriving an initial motion vector.

Alternatively, a motion vector of a neighboring block at a predefined position may be set as an initial motion vector.

Alternatively, an initial motion vector may be derived by using a template-based motion estimation method (i.e., a template matching method) or bilateral matching.

The precision of an initial motion vector may be predefined in an encoder and a decoder. As an example, the precision of an initial motion vector may be fixed in an integer pixel unit.

Alternatively, information indicating the precision of an initial motion vector may be explicitly encoded and signaled. The information may be an index indicating one of a plurality of motion vector precision candidates.

When an initial motion vector is derived by using a motion vector prediction candidate, motion vector prediction candidates may be derived based on the motion vector precision of an initial motion vector. In other words, after adjusting a motion vector prediction candidate according to the motion vector precision of an initial motion vector, an adjusted initial motion vector prediction candidate may be inserted into a motion vector prediction list.

When an initial motion vector is derived by using a motion information merge candidate, motion information merge candidates may be derived based on the motion vector precision of an initial motion vector. In other words, after adjusting a motion information merge candidate according to the motion vector precision of an initial motion vector, an adjusted initial motion information merge candidate may be inserted into a motion information merge list.

Meanwhile, among the motion information merge candidates included in a motion information merge list, only candidates whose reference picture is the same as a collocated picture of a current block may be used to derive an initial motion vector. In other words, when a reference picture of a motion information merge candidate is different from a collocated picture of a current block, an initial motion vector may not be derived from a corresponding motion information merge candidate.

When there are a plurality of candidates whose reference picture is the same as a collocated picture of a current block among the motion information merge candidates, an index indicating one of a plurality of candidates may be encoded and signaled. Alternatively, when there are a plurality of candidates whose reference picture is the same as a collocated picture of a current block among the motion information merge candidates, an initial motion vector may be derived from a candidate with the smallest index or a candidate with the largest index among a plurality of candidates.

When a motion information merge candidate has both motion information in a L0 direction and motion information in a L1 direction, one of motion information in a L0 direction and motion information in a L1 direction may be selected according to a preset priority and an initial motion vector may be derived from selected motion information.

A priority may be determined based on at least one of a size of a motion vector of a motion merge candidate, an index of a reference picture of a motion merge candidate or whether a reference picture of a motion merge candidate is the same as a collocated picture.

Alternatively, it may be set to derive an initial motion vector based on motion information in a L0 direction.

When an initial motion vector is derived based on a template matching method, motion estimation may be performed according to the precision of an initial motion vector. As an example, when the precision of an initial motion vector is an integer pixel unit, motion estimation based on template matching may also be performed only at an integer position.

Likewise, when an initial motion vector is derived based on bilateral matching, motion estimation may be performed according to the precision of an initial motion vector.

Meanwhile, as a result of bilateral matching, a motion vector for a L0 direction (a L0 motion vector) and a motion vector for a L1 direction (a L1 motion vector) are derived. In this case, one of a L0 motion vector and a L1 motion vector may be set as an initial motion vector according to a preset priority.

Alternatively, it may be set to derive an initial motion vector based on motion information in a L0 direction.

Alternatively, information indicating which of a L0 motion vector and a L1 motion vector is set as an initial motion vector may be encoded and signaled

If an initial motion vector is derived, a position of a collocated block in a collocated block may be determined by using an initial motion vector. As an example, a block at a position separated by an initial motion vector from a position corresponding to a current block in a reference picture may be set as a collocated block. In this case, a position of a collocated block may be determined based on a predefined position in a current block. Here, a predefined position may be a top-left position, a top-right position, a bottom-left position, a bottom-right position or a center position.

According to a partition method of a current block, a collocated block may be partitioned into a plurality of collocated sub-blocks. And, a motion vector of each collocated sub-block in a collocated block may be set as a motion vector of each sub-block in a current block.

As another example, an initial motion vector may be used to determine a position of collocated sub-blocks corresponding to each sub-block in a current block within a collocated picture. In this case, a position of a collocated sub-block may be derived based on a predefined position in a sub-block. Here, a predefined position may be a top-left position, a top-right position, a bottom-left position, a bottom-right position or a center position.

Afterwards, a motion vector of a collocated sub-block corresponding to a sub-block may be set as a motion vector of a sub-block. Specifically, a motion vector stored at a position corresponding to a predefined position in a sub-block within a collocated sub-block may be set as a motion vector of a sub-block.

Meanwhile, when the motion information of a collocated sub-block is unavailable, a predefined motion vector may be set as a motion vector of a sub-block. Here, a predefined motion vector may be a zero vector (i.e., (0, 0)) or an initial motion vector.

Alternatively, when the motion information of a collocated sub-block corresponding to a sub-block is unavailable, a motion vector of a sub-block may be derived from another position within a collocated sub-block.

Specifically, when a position corresponding to a predefined position in a sub-block within a collocated sub-block is encoded by intra prediction, a motion vector does not exist at a corresponding position. As an example, when it is assumed that a predefined position is a center position (e.g., c10 in FIG. 20), if a motion vector is not stored at a center position, a motion vector of a sub-block may not be derived.

In this case, a motion vector of a sub-block may be derived based on a motion vector stored at a position different from a center position. Specifically, a motion vector of a sub-block may be derived from a motion vector stored at a position adjacent to a center position (e.g., top adjacent position c6, left adjacent position c9 or top-left adjacent position c5).

Alternatively, when a center position is not available, samples in a collocated sub-block may be searched according to scan order and an available motion vector found first may be set as a motion vector of a sub-block. Here, scan order may be horizontal scan, vertical scan, diagonal scan or raster scan.

Alternatively, when the motion information of a collocated sub-block is not available, a motion vector of a sub-block may be set as a motion vector of a collocated block. As an example, a motion vector stored at a position corresponding to a predefined position in a current block within a collocated block may be set as a motion vector of a sub-block.

As in an example described above, a motion vector may be derived in a unit of a sub-block by using an affine motion model or SbTMVP. When a motion vector is derived in a unit of a sub-block, motion compensation may be performed for each sub-block based on a motion vector of each sub-block.

By performing motion compensation for each sub-block, a prediction block for a current block may be obtained. In other words, the prediction block may be composed of prediction samples of each sub-block.

Meanwhile, when motion compensation is performed in a unit of a sub-block, discontinuity may occur at a boundary between sub-blocks in a current block. The present disclosure provides a method for generating a plurality of prediction blocks for a current block and weighting a plurality of prediction blocks to remove discontinuity occurring at a boundary between sub-blocks.

Specifically, a first prediction block for a current block may be obtained by applying a first partition type to a current block. In other words, motion compensation may be performed for each sub-block generated by applying a first partition type, obtaining a first prediction block for a current block.

In addition, a second prediction block for a current block may be obtained by applying a second partition type to a current block. In other words, motion compensation may be performed for each sub-block generated by applying a second partition type, obtaining a second prediction block for a current block.

Afterwards, a final prediction block for a current block may be obtained through the weighted sum of a first prediction block and a second prediction block.

Meanwhile, between a first partition type and a second partition type, at least one of a size and/or a shape of a sub-block generated by partitioning a current block and the number and/or a position of partition lines partitioning a current block may be different

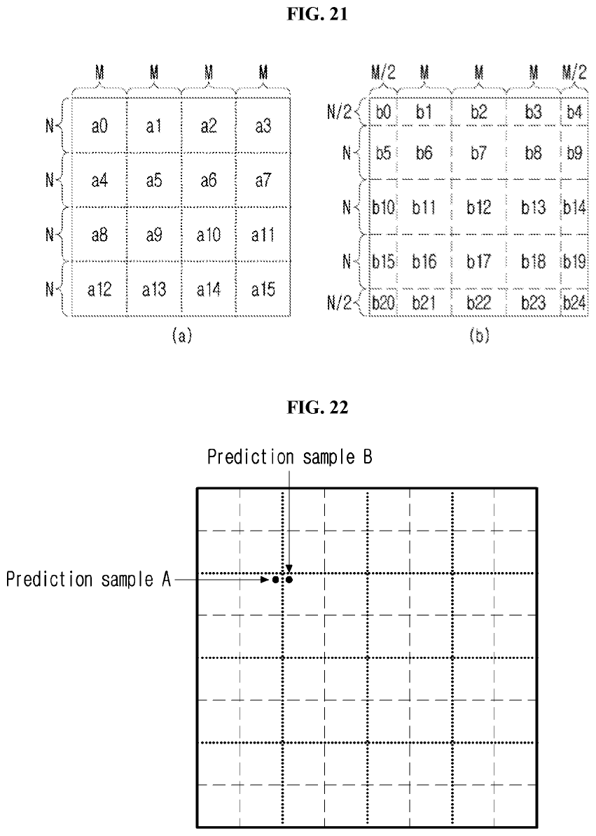

FIG. 21 is a diagram illustrating a first partition type and a second partition type.

If it is assumed that M is 4, a first partition type shown in FIG. 21(a) represents a partition method in which a current block is evenly partitioned into 4×4-sized sub-blocks.

On the other hand, for a second partition type shown in FIG. 21(b), it was illustrated that a horizontal partition line and a vertical partition line that partition a current block are positioned with an offset interval of 2 compared to a horizontal partition line and a vertical partition line in a first partition type, respectively. In other words, when a second partition type is applied, horizontal partition lines of a current block may be seperated by 4 in a y-axis direction, starting at a position of (0, 2), and vertical partition lines of a current block may be separated by 4 in a x-axis direction, starting at a position of (2, 0).

Meanwhile, when a second partition type is applied, sub-blocks positioned at a boundary of a current block may be derived to have a size of 2×2, 2×4 or 4×2.

A weighted sum operation on a first prediction block obtained by applying a first partition type and a second prediction block obtained by applying a second partition type may be performed to obtain a final prediction block for a current block.

FIG. 22 is to describe a weighted sum operation for a first prediction block obtained based on a first partition type and a second prediction block obtained based on a second partition type shown in FIG. 21.

According to an example shown in FIG. 22, a boundary position between sub-blocks when a first partition type is applied is continuously distributed in a specific sub-block under a second partition type.

As an example, in an example shown in FIG. 22, when a first partition type is applied, each of prediction sample A and prediction sample B belongs to a different sub-block, but when a second partition type is applied, prediction sample A and prediction sample B belong to one sub-block.

Accordingly, through the weighted sum of a first prediction block obtained by a first partition type and a second prediction block obtained by a second partition type, discontinuity existing at a boundary between sub-blocks may be removed.

In performing a weighted sum operation for a first prediction block and a second prediction block, a first weight allocated to a first prediction block and a second weight allocated to a second prediction block may be set as the same value. In other words, both a first weight and a second weight may be ½.

Alternatively, in order to avoid a real number operation, a first weight and a second weight may be changed into an integer and a result of a weighted sum operation may be shifted to the right to obtain a final prediction sample. As an example, when the sum of a first weight and a second weight is an integer expressed as 2\hat{ }N, a result of a weighted sum operation may be shifted to the right by N to obtain a final prediction sample.

Alternatively, one of a first weight and a second weight may be determined by using a weight candidate list. In this case, an index indicating one of the weight candidates included in a weight candidate list may be encoded and signaled.

Specifically, one of a first weight and a second weight may be set to be the same as a weight candidate indicated by an index, and the other may be derived by subtracting a weight candidate indicated by an index from a predefined constant. A predefined constant may be an integer expressed as an exponent of 2 such as 1, 2, 4, 8 or 16.

Alternatively, according to a position of a sub-block, a size of a sub-block or a shape of a sub-block in a current block, a first weight applied to a first prediction sample in a first prediction block and a second weight applied to a second prediction sample in a second prediction block may be adaptively determined. As an example, when a size of a first sub-block including a current prediction position when a first partition type is applied is larger than a size of a second sub-block including a current prediction position when a second partition type is applied, a first weight may be set as a value larger than a second weight.

Alternatively, based on whether a current prediction position is positioned at a boundary of a sub-block, a first weight applied to a first prediction sample in a first prediction block and a second weight applied to a second prediction sample in a second prediction block may be adaptively determined. As an example, when a current prediction position when a first partition type is applied is adjacent to a boundary of a first sub-block, whereas a current prediction position when a second partition type is applied is not adjacent to a boundary of a second sub-block, a first weight may be set as a value smaller than a second weight.

Each of a first prediction block and a second prediction block may be obtained by applying an affine model or SbTMVP to a current block.

Meanwhile, a plurality of motion information derivation methods may be used to obtain a plurality of prediction blocks.

As an example, a first prediction block may be obtained by using a first motion information derivation method, and a second prediction block may be obtained by using a second motion information derivation method that is different from a first motion information derivation method.

Here, a first motion information derivation method and a second motion information derivation method may be different in at least one of a position of a sample used to derive a motion vector or a motion compensation model.

As an example, a first motion information derivation method may be an affine model, and a second motion information derivation method may be a SbTMVP method.

Alternatively, a first motion information derivation method may derive a motion vector based on a center position of a sub-block (c10 in FIG. 20), and a second motion information derivation method may derive a motion vector based on a top-left position of a center position of a sub-block (c5 in FIG. 20).

Meanwhile, while maintaining a partition method for a current block in the same manner, a plurality of prediction blocks may be obtained by using a plurality of motion information derivation methods.

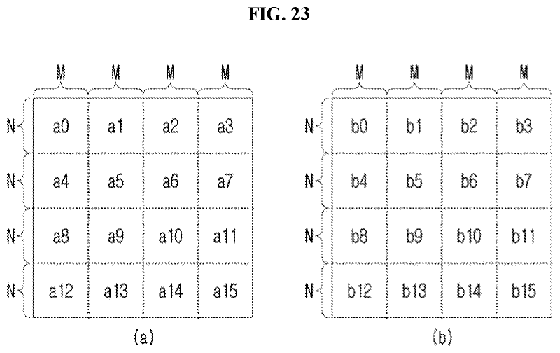

FIG. 23 represents an example in which a plurality of prediction blocks are obtained while maintaining a partition method in the same manner.

As in an example shown in FIG. 23(a), after a current block is evenly partitioned into M×M-sized sub-blocks, a first prediction block may be obtained based on a first motion information derivation method. In addition, as in an example shown in FIG. 23(b), a second prediction block may be obtained by using a second motion information derivation method after applying the same partition type.

Afterwards, a final prediction block for a current block may be obtained based on a weighted sum operation for a first prediction block and a second prediction block.

Obtaining a plurality of prediction blocks may also be performed for each of L0 prediction and L1 prediction. As an example, when a L0 prediction flag for a current block is 1, a first L0 prediction block and a second L0 prediction block may be obtained for a L0 direction, and then a final L0 prediction block may be obtained through the weighted sum of a first L0 prediction block and a second L0 prediction block. In addition, when a L1 prediction flag for a current block is 1, a first L1 prediction block and a second L1 prediction block may be obtained for a L1 direction, and then a final L1 prediction block may be obtained through the weighted sum of a first L1 prediction block and a second L1 prediction block.

Afterwards, a final prediction block for a current block may be obtained based on a weighted sum operation of a final L0 prediction block and a final L1 prediction block.

When embodiments described based on a decoding process or an encoding process are applied to an encoding process or a decoding process, it is included in a scope of the present disclosure. When embodiments described in predetermined order are changed in order different from a description, it is also included in a scope of the present disclosure.

The above-described embodiment is described based on a series of steps or flow charts, but it does not limit a time series order of the present disclosure and if necessary, it may be performed at the same time or in different order. In addition, each component (e.g., a unit, a module, etc.) configuring a block diagram in the above-described embodiment may be implemented as a hardware device or software and a plurality of components may be combined and implemented as one hardware device or software. As an example, the hardware device may include at least one of a processor for performing an operation, a memory for storing data, a transmitter for transmitting data and a receiver for receiving data.

The above-described embodiment may be recorded in a computer readable recoding medium by being implemented in a form of a program instruction which may be performed by a variety of computer components. The computer readable recoding medium may include a program instruction, a data file, a data structure, etc. solely or in combination.

In addition, according to the present disclosure, a computer readable recording medium storing a bitstream generated by the above-described encoding method may be provided. The bitstream may be transmitted by an encoding device, and a decoding device may receive the bitstream to decode an image.

A hardware device which is specially configured to store and perform magnetic media such as a hard disk, a floppy disk and a magnetic tape, optical recording media such as CD-ROM, DVD, magneto-optical media such as a floptical disk and a program instruction such as ROM, RAM, a flash memory, etc. is included in a computer readable recoding medium. The hardware device may be configured to operate as one or more software modules in order to perform processing according to the present disclosure and vice versa.

### INDUSTRIAL AVAILABILITY

The present disclosure may be applied to a computing or electronic device which may encode/decode a video signal.

1. A method of decoding a video, the method comprising:
obtaining a first prediction block for a current block;
obtaining a second prediction block for the current block; and
obtaining a final prediction block for the current block based on a weighted sum operation of the first prediction block and the second prediction block,
wherein the first prediction block is obtained by performing a motion compensation on each of first sub-blocks generated when a first partition type is applied to the current block, and
wherein the second prediction block is obtained by performing a motion compensation on each of second sub-blocks generated when a second partition type is applied to the current block.

2. The method of claim 1, wherein the first partition type and the second partition type are different in at least one of a position of a partition line partitioning the current block, a number of partition lines, a size of a sub-block generated by partitioning the current block or a shape of a sub-block.

3. The method of claim 2, wherein the first sub-blocks generated by the first partition type have an equal size, and
wherein among the second sub-blocks generated by the second partition type, a part of the second sub-blocks not adjacent to a boundary of the current block have the equal size, and the others of the second sub-blocks adjacent to the boundary of the current block have a smaller size.

4. The method of claim 1, wherein the weighted sum operation is performed by applying a first weight to the first prediction block and applying a second weight to the second prediction block.

5. The method of claim 1, wherein the first weight and the second weight are variably determined according to a prediction target position.

6. The method of claim 1, wherein a motion compensation for the first sub-blocks is performed based on a first motion information derivation method, and
wherein a motion compensation for the second sub-blocks is performed based on a second motion information derivation method.

7. The method of claim 6, wherein the first motion information derivation method is an affine model, and
wherein the second motion information derivation method is a Sub-block Temporal Motion Vector Prediction (SbTMVP).

8. The method of claim 6, wherein motion information for the first sub-blocks to which the first motion information derivation method is applied is derived based on a first position of a sub-block, and
wherein motion information for the second sub-blocks to which the second motion information derivation method is applied is derived based on a second position of the sub-block.

9. A method of encoding a video, the method comprising:
obtaining a first prediction block for a current block;
obtaining a second prediction block for the current block; and
obtaining a final prediction block for the current block based on a weighted sum operation of the first prediction block and the second prediction block,
wherein the first prediction block is obtained by performing a motion compensation on each of first sub-blocks generated when a first partition type is applied to the current block, and
wherein the second prediction block is obtained by performing a motion compensation on each of second sub-blocks generated when a second partition type is applied to the current block.

10. The method of claim 9, wherein the first partition type and the second partition type are different in at least one of a position of a partition line partitioning the current block, a number of partition lines, a size of a sub-block generated by partitioning the current block or a shape of a sub-block.

11. The method of claim 10, wherein the first sub-blocks generated by the first partition type have an equal size, and
among the second sub-blocks generated by the second partition type, a part of the second sub-blocks not adjacent to a boundary of the current block have the equal size, and the others of the second sub-blocks adjacent to the boundary of the current block have a smaller size.

12. The method of claim 9, wherein the weighted sum operation is performed by applying a first weight to the first prediction block and applying a second weight to the second prediction block.

13. The method of claim 9, wherein the first weight and the second weight are variably determined according to a prediction target position.

14. The method of claim 9, wherein a motion compensation for the first sub-blocks is performed based on a first motion information derivation method, and
wherein a motion compensation for the second sub-blocks is performed based on a second motion information derivation method.

15. A computer readable recording medium storing a bitstream generated by an image encoding method, the encoding method comprising:
obtaining a first prediction block for a current block;
obtaining a second prediction block for the current block; and
obtaining a final prediction block for the current block based on a weighted sum operation of the first prediction block and the second prediction block,
wherein the first prediction block is obtained by performing a motion compensation on each of first sub-blocks generated when a first partition type is applied to the current block, and
wherein the second prediction block is obtained by performing a motion compensation on each of second sub-blocks generated when a second partition type is applied to the current block.
